(19) United States
(12) Patent Application Publication
(10) Pub. No.: US 2014/0307622 A1
(43) Pub. Date: Oct. 16, 2014

(54) PACKET-LEVEL SPLITTING FOR DATA TRANSMISSION VIA MULTIPLE CARRIERS

(71) Applicant: QUALCOMM Incorporated, San Diego, CA (US)

(72) Inventors: Gavin Bernard Horn, La Jolla, CA (US); Jelena Damnjanovic, Del Mar, CA (US); Rajat Prakash, San Diego, CA (US)

(73) Assignee: QUALCOMM Incorporated, San Diego, CA (US)

(21) Appl. No.: 14/249,050

(22) Filed: Apr. 9, 2014

Related U.S. Application Data
(60) Provisional application No. 61/811,637, filed on Apr. 12, 2013.

(51) Int. Cl. H04L 12/709; H04W 28/10

(52) U.S. Cl. CPC H04L 45/245; H04W 28/10
USPC 370/328

(57) ABSTRACT

Packet-level splitting for data transmission via multiple carriers is discussed. Data packets for transmission may be segregated by a first network node into multiple flows in which data packets for a first flow may be sent from the first network node to a second network node using a first set of carriers while data packets for the other flows may be forwarded to other network nodes for transmission to the second network node using other sets of carriers. The various sets of carriers are determined by the sets of carriers configured for the second network node.

### CROSS-REFERENCE TO RELATED APPLICATIONS

This application claims the benefit of U.S. Provisional Patent Application No. 61/811,637, entitled, “PACKET-LEVEL SPLITTING FOR DATA TRANSMISSION VIA MULTIPLE CARRIERS,” filed on Apr. 12, 2013, which is expressly incorporated by reference herein in its entirety.

### BACKGROUND

I. Field

The present disclosure relates generally to communication, and more specifically to techniques for supporting data transmission in a wireless communication network.

II. Background

Wireless communication networks are widely deployed to provide various communication content such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A wireless communication network may support operation on multiple carriers. A carrier may refer to a range of frequencies used for communication and may be associated with certain characteristics. For example, a carrier may be associated with system information describing operation on the carrier. A carrier may also be referred to as a component carrier (CC), a frequency channel, a cell, etc. A base station may transmit data and/or control information on multiple carriers to a UE for carrier aggregation. The UE may transmit data and/or control information on multiple carriers to the base station.

### BRIEF DESCRIPTION OF THE DRAWING

For a more complete understanding of the present invention, reference is now made to the following descriptions taken in conjunction with the accompanying drawing, in which:

FIG. 1 is a block diagram illustrating a wireless communication network, which may be an LTE network or some other wireless network.

FIG. 2 is a block diagram illustrating an exemplary design of a network architecture supporting packet-level splitting.

FIG. 3 is a block diagram illustrating exemplary processing for Packet Data Convergence Protocol (PDCP), Radio Link Control (RLC), and Medium Access Control (MAC) at a transmitter, which may be a UE for data transmission on the uplink or an eNB for data transmission on the downlink.

FIG. 4A is a block diagram illustrating a design of packet-level splitting at a PDCP layer for downlink data transmission.

FIG. 4B is a block diagram illustrating a design of packet-level splitting at PDCP layer for uplink data transmission.

FIG. 5A is a block diagram illustrating a design of packet-level splitting at RLC layer for downlink data transmission.

FIG. 5B is a block diagram illustrating a design of packet-level splitting at RLC layer for uplink data transmission.

FIG. 6 is a block diagram illustrating a design of packet-level splitting at MAC layer for downlink data transmission.

FIG. 7A is a block diagram illustrating an example of flow-to-carrier mapping for downlink data transmission to a UE on non-overlapping sets of carriers at two eNBs.

FIG. 7B is a block diagram illustrating an example of flow-to-carrier mapping for downlink data transmission to a UE on overlapping sets of carriers at two eNBs.

FIG. 8 is a block diagram illustrating a design of disjoint uplink and downlink data channels at two cells for a UE.

FIG. 9 is a functional block diagram illustrating example blocks executed for sending data in a wireless network.

FIG. 10 is a functional block diagram illustrating example blocks executed for receiving data in a wireless network.

FIG. 11 is a functional block diagram illustrating example blocks executed for sending data in a wireless network.

FIG. 12 is a functional block diagram illustrating example blocks executed for receiving data in a wireless network.

FIG. 13 is a functional block diagram illustrating example blocks executed for sending data in a wireless network.

FIG. 14 is a block diagram illustrating an exemplary design of a UE and eNB/base station as depicted in FIG. 1.

### DETAILED DESCRIPTION

Techniques to support communication via multiple carriers in a wireless communication network are disclosed herein. These techniques may be used for various wireless communication networks such as CDMA, TDMA, FDMA, OFDMA, SC-FDMA and other wireless networks. The terms “network” and “system” are often used interchangeably. A CDMA network may implement a radio technology such as Universal Terrestrial Radio Access (UTRA), cdma2000, etc. UTRA includes Wideband CDMA (WCDMA), Time Division Synchronous CDMA (TD-SCDMA), and other variants of CDMA. cdma2000 includes IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi and Wi-Fi Direct), IEEE 802.16 (WiMAX), IEEE 802.20, Flash-OFDM®, etc. UTRA, E-UTRA, and GSM are part of Universal Mobile Telecommunication System (UMTS). 3GPP Long Term Evolution (LTE) and LTE-Advanced (LTE-A), in both frequency division duplexing (FDD) and time division duplexing (TDD), are recent releases of UMTS that use E-UTRA, which employs OFDMA on the downlink and SC-FDMA on the uplink. UTRA, E-UTRA, GSM, UMTS, LTE and LTE-A are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

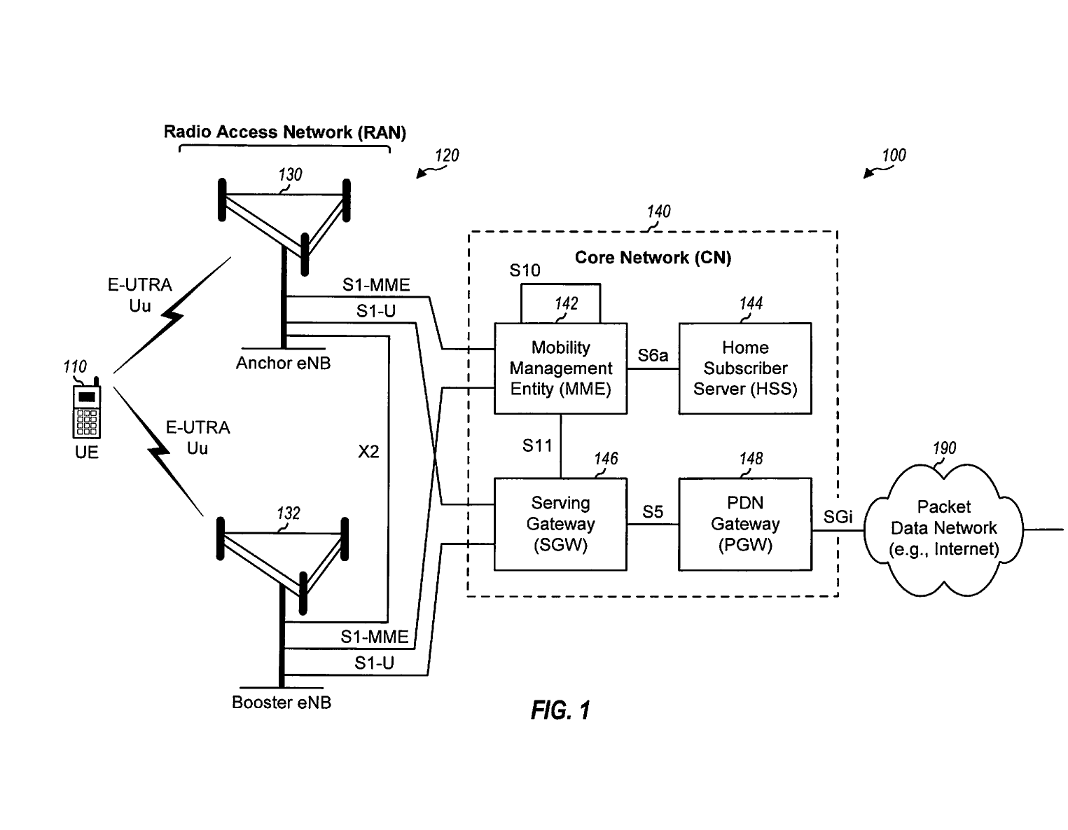

FIG. 1 shows a wireless communication network 100, which may be an LTE network or some other wireless network. Wireless network 100 may include a radio access network (RAN) 120 that supports radio communication and a core network (CN) 140 that supports data communication and/or other services. RAN 120 may also be referred to as an Evolved Universal Terrestrial Radio Access Network (E-UTRAN).

RAN 120 may include a number of evolved Node Bs (eNBs) that support radio communication for UEs. For simplicity, only two eNBs 130 and 132 are shown in FIG. 1. An eNB may be an entity that communicates with the UEs and may also be referred to as a Node B, a base station, an access point, etc. Each eNB may provide communication coverage for a particular geographic area and may support radio communication for the UEs located within the coverage area. To improve network capacity, the overall coverage area of an eNB may be partitioned into multiple (e.g., three) smaller areas. Each smaller area may be served by a respective eNB subsystem. In 3GPP, the term “cell” can refer to a coverage area of an eNB and/or an eNB subsystem serving this coverage area. eNBs 130 and 132 may each be a macro eNB for a macro cell, a pico eNB for a pico cell, a home eNB for a femto cell, etc. For example, eNBs 130 and 132 may be two macro eNBs. As another example, eNB 130 may be a macro eNB, and eNB 132 may be a femto eNB or a Wi-Fi access point. Each eNB may serve one cell or multiple (e.g., three) cells. RAN 120 may also include other network entities that are not shown in FIG. 1 for simplicity.

Core network 140 may include a Mobility Management Entity (MME) 142, a Home Subscriber Server (HSS) 144, a serving gateway (SGW) 146, and a Packet Data Network (PDN) gateway (PGW) 148. Core network 140 may also include other network entities that are not shown in FIG. 1 for simplicity.

MME 142 may perform various functions such as control of signaling and security for a Non Access Stratum (NAS), authentication and mobility management of UEs, selection of gateways for UEs, bearer management functions, etc. HSS 144 may store subscription-related information (e.g., user profiles) and location information for users, perform authentication and authorization of users, and provide information about user location and routing information when requested.

Serving gateway 146 may perform various functions related to Internet Protocol (IP) data transfer for UEs such as data routing and forwarding, mobility anchoring, etc. Serving gateway 146 may also terminate the interface towards RAN 120 and may perform various functions such as support for handover between eNBs, buffering, routing and forwarding of data for UEs, initiation of network-triggered service request procedure, accounting functions for charging, etc.

PDN gateway 148 may perform various functions such as maintenance of data connectivity for UEs, IP address allocation, packet filtering for UEs, service level gating control and rate enforcement, dynamic host configuration protocol (DHCP) functions for clients and servers, gateway GPRS support node (GGSN) functionality, etc. PDN gateway 148 may also terminate an SGi interface toward a packet data network 190, which may be the Internet, a packet data network of a network operator, etc. SGi is a reference point between a PDN gateway and a packet data network for provision of data services.

FIG. 1 also shows exemplary interfaces between various network entities in RAN 120 and core network 140. eNBs 130 and 132 may communicate with each other via an X2 interface. eNBs 130 and 132 may communicate with MME 142 via an S1-MME interface and with serving gateway 146 via an S1-U interface. MME 142 may communicate with HSS 144 via an S6a interface and may communicate with serving gateway 146 via an S11 interface. Serving gateway 146 may communicate with PDN gateway 148 via an S5 interface.

The various network entities in RAN 120 and core network 140 and the interfaces between the network entities are described in 3GPP TS 36.300, entitled “Evolved Universal Terrestrial Radio Access (E-UTRA) and Evolved Universal Terrestrial Radio Access Network (E-UTRAN); Overall description,” and in 3GPP TS 23.401, entitled “General Packet Radio Service (GPRS) enhancements for Evolved Universal Terrestrial Radio Access Network (E-UTRAN) access.” These documents are publicly available from 3GPP.

A UE 110 may communicate with one or more eNBs at any given moment for radio communication. UE 110 may be stationary or mobile and may also be referred to as a mobile station, a terminal, an access terminal, a subscriber unit, a station, etc. UE 110 may be a cellular phone, a smartphone, a tablet, a wireless communication device, a personal digital assistant (PDA), a wireless modem, a handheld device, a laptop computer, a cordless phone, a wireless local loop (WLL) station, a netbook, a smartbook, etc.

Wireless network 100 may support operation on multiple carriers, which may be referred to as carrier aggregation or multi-carrier operation. A carrier may refer to a range of frequencies used for communication and may be associated with certain characteristics. For example, a carrier may be associated with system information describing operation on the carrier. A carrier may also be referred to as a component carrier (CC), a frequency channel, a cell, etc.

UE 110 may be configured with multiple carriers for the downlink (or downlink carriers) and one or more carriers for the uplink (or uplink carriers) for carrier aggregation. One or more eNBs may transmit data and/or control information on one or more downlink carriers to UE 110. UE 110 may transmit data and/or control information on one or more uplink carriers to one or more eNBs.

Wireless network 100 may support communication via a user plane and a control plane. A user plane is a mechanism for carrying data for higher-layer applications and employing a user-plane bearer, which is typically implemented with standard protocols such as User Datagram Protocol (UDP), Transmission Control Protocol (TCP), and Internet Protocol (IP). A control plane is a mechanism for carrying data (e.g., signaling) and is typically implemented with network-specific protocols, interfaces, and signaling messages such as NAS messages and Radio Resource Control (RRC) messages. For example, traffic/packet data may be sent between UE 110 and wireless network 100 via the user plane. Signaling for various procedures to support communication for UE 110 may be sent via the control plane.

UE 110 may be configured with one or more data bearers for data communication with carrier aggregation. A bearer may refer to an information transmission path of defined characteristics, e.g., defined capacity, delay, bit error rate, etc. A data bearer is a bearer for exchanging data and may terminate at a UE and a network entity (e.g., a PDN gateway) designated to route data for the UE. A data bearer may also be referred to as an Evolved Packet System (EPS) bearer in LTE, etc.

A data bearer may be established when UE 110 connects to a designated network entity (e.g., a PDN gateway) and may remain established for the lifetime of the connection in order to provide UE 110 with always-on IP connectivity. This data bearer may be referred to as a default data bearer. One or more additional data bearers may be established to the same network entity (e.g., the same PDN gateway) and may be referred to as dedicated data bearer(s). Each additional data bearer may be associated with various characteristics such as (i) one or more traffic flow templates (TFTs) used to filter packets sent via the data bearer, (ii) quality-of-service (QoS) parameters for data transfer between the UE and the designated network entity, (iii) packet forwarding treatment related to scheduling policy, queue management policy, rate shaping policy, Radio Link Control (RLC) configuration, etc., and/or (iv) other characteristics. For example, UE 110 may be configured with one data bearer for transfer of data for a Voice-over-IP (VoIP) call, another data bearer for Internet download traffic, etc.

In summary, a default data bearer may be established with each new data connection (e.g., each new PDN connection), and its context may remain established for the lifetime of the data connection. The default data bearer may be a non-guaranteed bit rate (GBR) bearer. A dedicated data bearer may be associated with uplink packet filters in a UE and downlink packet filters in a designated network (e.g., a PDN gateway), where the packet filters for each link may only match certain packets. Each data bearer may correspond to a radio bearer. The default data bearer may be best effort and may carry all packets for an IP address that do not match the packet filters of any of the dedicated data bearers. The dedicated data bearers may be associated with traffic of a specific type (e.g., based on the packet filters) and may be associated with certain QoS.

In an aspect of the present disclosure, packet-level splitting may be used for data transmission on multiple carriers. Packet-level splitting refers to demultiplexing or partitioning of data packets for transmission via multiple flows/paths at multiple eNBs on multiple sets of one or more carriers, one set of carrier(s) for each flow/path. Packet-level splitting may also be referred to as packet-level aggregation. A UE may communicate with multiple eNBs on multiple carriers for carrier aggregation. For packet-level splitting on the downlink, packets intended for the UE may be received by an anchor eNB and may be split among the multiple eNBs with which the UE communicates. Each eNB may transmit packets to the UE on a set of downlink carriers configured for the UE at that eNB. For packet-level splitting on the uplink, packets to be sent by the UE may be split among the multiple eNBs with which the UE communicates. The UE may transmit packets to each eNB on a set of uplink carriers configured for the UE at that eNB.

eNBs may be selected to send or receive packets of a UE based on various criteria such as channel conditions, loading, etc. In one design, eNBs may be selected to send or receive packets of the UE on a per packet basis, so that a specific eNB may be selected to serve each packet of the UE. Each packet of the UE may be sent or received via the eNB selected for that packet. In other designs, eNBs may be selected to send or receive groups of packets, or packets identified in various manners, to/from the UE.

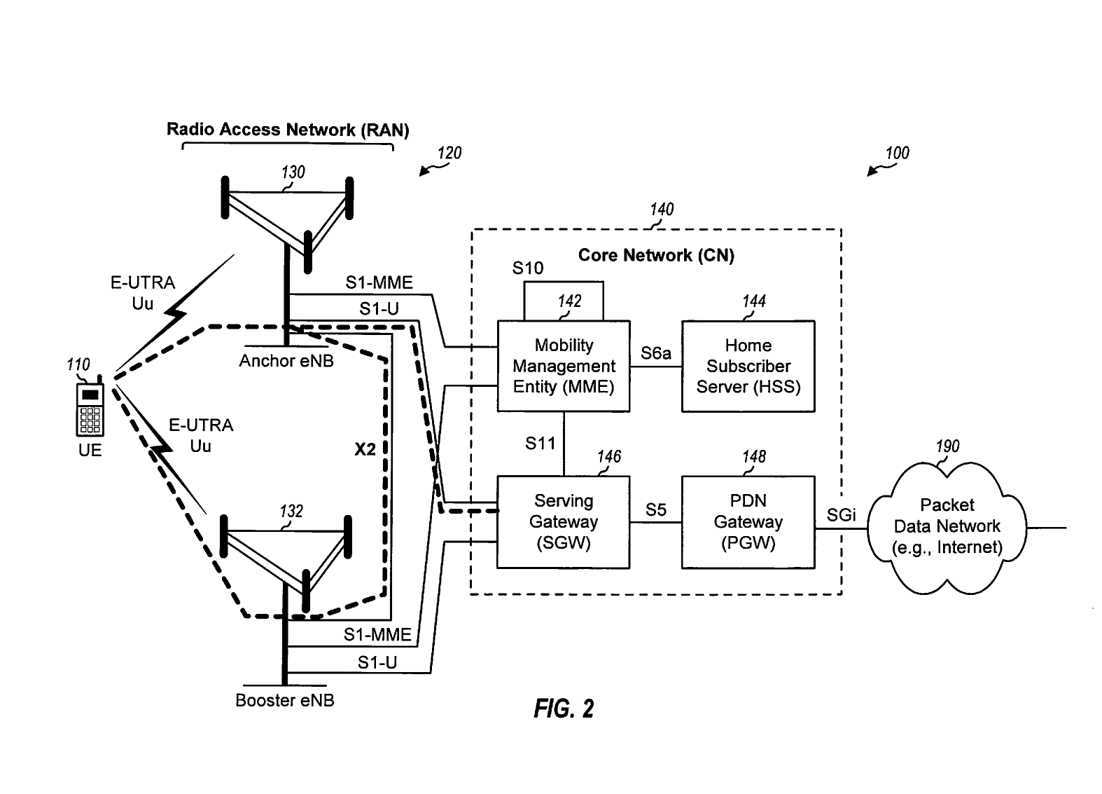

FIG. 2 shows an exemplary design of a network architecture supporting packet-level splitting. UE 110 may communicate with multiple eNBs 130 and 132 for carrier aggregation. eNB 130 may be an anchor eNB for UE 110, and eNB 132 may be a booster eNB for UE 110. An anchor eNB may be an eNB designated to control communication for a UE. An anchor eNB may also be referred to as a serving eNB, a primary eNB, a main eNB, etc. A booster eNB may be an eNB selected to exchange data with a UE, e.g., transmit data to and/or receive data from the UE. A booster eNB may also be referred to as a secondary eNB, a supplemental eNB, etc. From the perspective of UE 110, anchor eNB 130 may be considered as a primary cell (PCell), and booster eNB 132 may be considered as a secondary cell (SCell).

UE 110 may be configured with one or more data bearers for communication. Each data bearer may be served by anchor eNB 130 and possibly booster eNB 132. For each data bearer served by both eNBs 130 and 132, packets for the data bearer may be split between eNBs 130 and 132 as described below. MME 142 may manage the data bearer(s) of UE 110 and may determine how each data bearer of UE 110 is served, e.g., which eNB(s) to serve each data bearer of UE 110.

For data transmission on the downlink, packets intended for UE 110 may be received by PDN gateway 148, forwarded to serving gateway 146, and further forwarded to eNB 130. eNB 130 may perform packet-level splitting and may retain some packets intended for UE 110 and may forward remaining packets to booster eNB 132. Anchor eNB 130 may process and transmit the retained packets to UE 110 on a first set of downlink carriers configured for UE 110 at eNB 130. Similarly, booster eNB 132 may process and transmit the forwarded packets to UE 110 on a second set of downlink carriers configured for UE 110 at eNB 132.

For data transmission on the uplink, UE 110 may perform packet-level splitting for packets to send and may identify packets to send to anchor eNB 130 as well as packets to send to booster eNB 132. UE 110 may process the packets to send to anchor eNB 130 and may transmit these packets on a first set of uplink carriers to anchor eNB 130. UE 110 may also process the packets to send to booster eNB 132 and may transmit these packets on a second set of uplink carriers to booster eNB 132. Booster eNB 132 may receive and process the packets from UE 110 and may forward these packets to anchor eNB 130. Anchor eNB 130 may receive the packets from UE 110 and the packets from booster eNB 132, aggregate the packets received from UE 110 and booster eNB 132, and forward these packets to serving gateway 146. Serving gateway 146 may forward the packets for UE 110 to PDN gateway 148.

The network architecture in FIG. 2 may correspond to a reference network architecture for aggregation of separate data bearers of UE 110 terminating at RAN 120. Packet-level spitting may be performed in various manners, as described below.

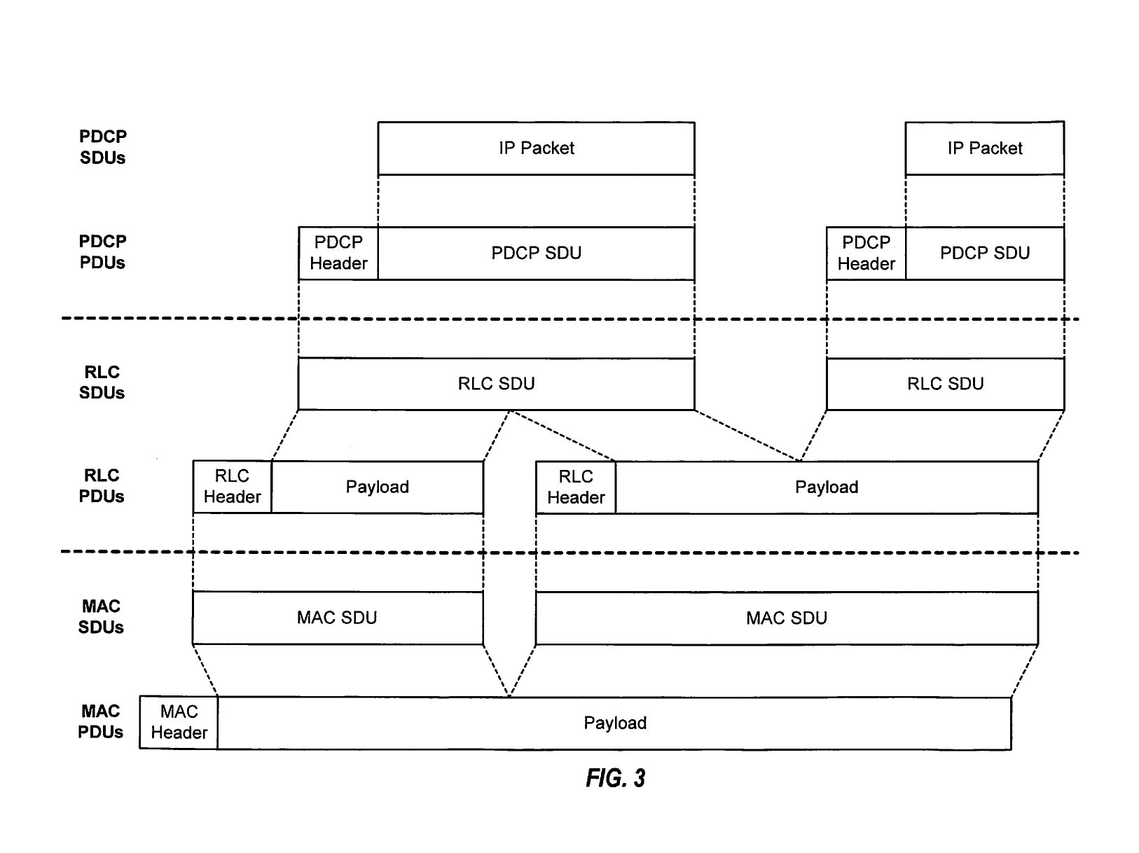

FIG. 3 shows exemplary processing for Packet Data Convergence Protocol (PDCP), Radio Link Control (RLC), and Medium Access Control (MAC) at a transmitter, which may be a UE for data transmission on the uplink or an eNB for data transmission on the downlink. Each layer may receive service data units (SDUs) from a layer above and provide protocol data units (PDUs) to a layer below.

PDCP may receive IP packets, which may be referred to as PDCP SDUs. PDCP may process each IP packet/PDCP SDU and provide a corresponding PDCP PDU. PDCP may perform various functions such as compression of upper layer protocol headers, ciphering/encryption, integrity protection of data for security, etc. PDCP may also assign a sequentially increasing PDCP sequence number (SN) to each PDCP PDU.

RLC may receive PDCP PDUs, which may be referred to as RLC SDUs. RLC may process the RLC SDUs and provide RLC PDUs of appropriate sizes for MAC. RLC may perform various functions such as segmentation and/or concatenation of RLC SDUs and error correction through Automatic Repeat reQuest (ARQ). RLC may assign a sequentially increasing RLC SN to each RLC PDU. RLC may also re-transmit RLC PDUs received in error by a receiver.

MAC may receive RLC PDUs, which may be referred to as MAC SDUs. MAC may process the MAC SDUs and provide MAC PDUs to physical layer (PHY). MAC may perform various functions such as mapping between logical channels and transport channels, multiplexing of MAC SDUs belonging to one or more logical channels to transport blocks (TB), error correction through hybrid ARQ (HARQ), etc.

The PDUs provided by each layer may also be referred to as packets. For data transmission, PDCP PDUs may be referred to as PDCP packets, RLC PDUs may be referred to as RLC packets, and MAC PDUs may be referred to as MAC packets. For data reception, MAC SDUs may be referred to as MAC packets, RLC SDUs may be referred to as RLC packets, and PDCP SDUs may be referred to as PDCP packets.

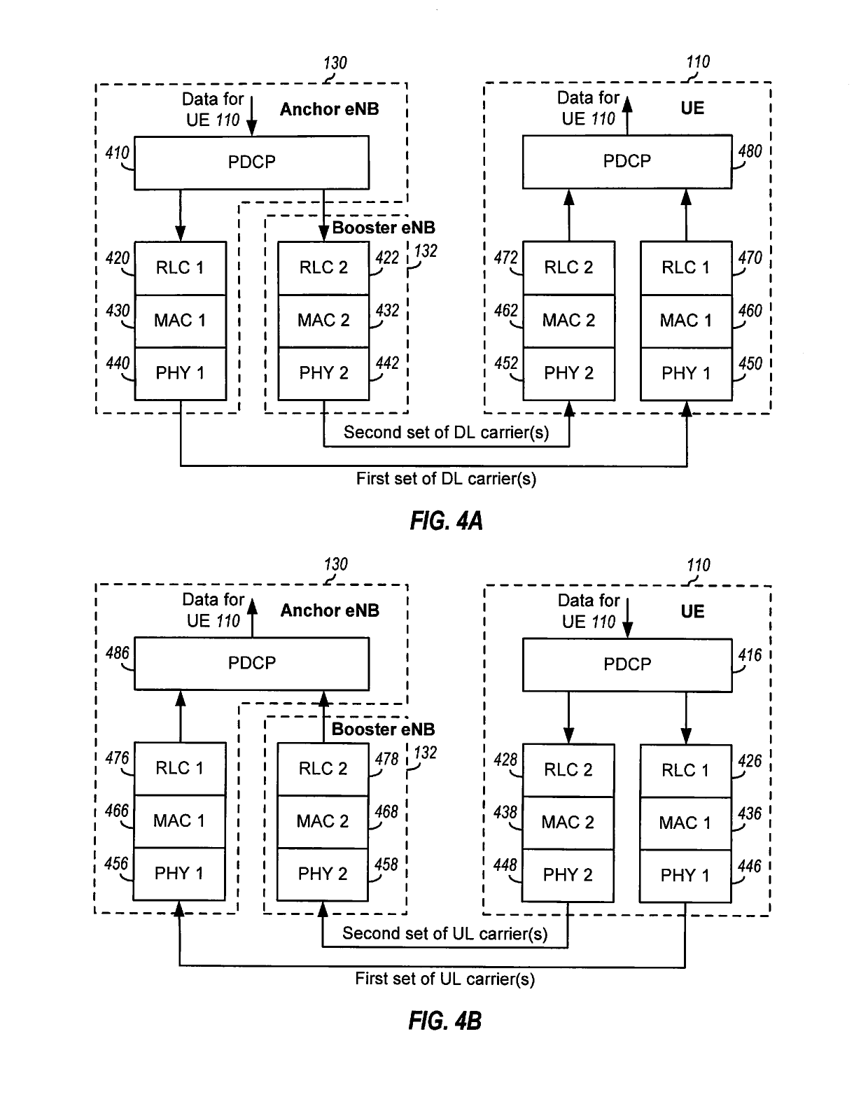

FIG. 4A shows a design of packet-level splitting at PDCP layer for downlink data transmission. Anchor eNB 130 may receive data (e.g., IP packets) for UE 110 (e.g., for a data bearer configured for UE 110). Anchor eNB 130 may process the received data for PDCP 410 and generate PDCP packets (e.g., PDCP PDUs). Anchor eNB 130 may perform packet-level splitting and may determine a first set of PDCP packets to transmit directly to UE 110 and a second set of PDCP packets to forward to booster eNB 132 for transmission to UE 110. Anchor eNB 130 may process the first set of PDCP packets for RLC 420, MAC 430, and PHY 440 and may generate one or more downlink signals comprising the first set of PDCP packets sent on a first set of downlink carriers configured for UE 110 at eNB 130. Anchor eNB 130 may forward the second set of PDCP packets to booster eNB 132. Booster eNB 132 may process the second set of PDCP packets for RLC 422, MAC 432, and PHY 442 and may generate one or more downlink signals comprising the second set of PDCP packets sent on a second set of downlink carriers configured for UE 110 at eNB 132.

At UE 110, the downlink signal(s) from anchor eNB 130 may be received and process by PHY 450, MAC 460, and RLC 470 to obtain RLC packets (e.g., RLC PDUs) from eNB 130. Similarly, the downlink signal(s) from booster eNB 132 may be received and process by PHY 452, MAC 462, and RLC 472 to obtain RLC packets from eNB 132. UE 110 may aggregate the RLC packets from eNBs 130 and 132, process the aggregated RLC packets for PDCP 480, and provide data (e.g., IP packets) sent to UE 110.

At UE 110, PDCP 480 may assume in-order delivery of RLC packets from RLCs 470 and 472. Since RLC packets may be sent from multiple eNBs 130 and 132, a mechanism may be used to ensure that RLCs 470 and 472 can provide RLC packets in order to PDCP 480.

FIG. 4B shows a design of packet-level splitting at PDCP layer for uplink data transmission. UE 110 may receive data (e.g., IP packets) to send on the uplink (e.g., for a data bearer configured for UE 110). UE 110 may process the received data for PDCP 416 and generate PDCP packets. UE 110 may perform packet-level splitting and may determine a first set of PDCP packets to transmit to anchor eNB 130 and a second set of PDCP packets to transmit to booster eNB 132. UE 110 may process the first set of PDCP packets for RLC 426, MAC 436, and PHY 446. UE 110 may also process the second set of PDCP packets for RLC 428, MAC 438, and PHY 448. UE 110 may generate one or more uplink signals comprising (i) the first set of PDCP packets sent on a first set of uplink carriers configured for UE 110 at eNB 130 and (ii) the second set of PDCP packets sent on a second set of uplink carriers configured for UE 110 at eNB 132.

At anchor eNB 130, the uplink signal(s) from UE 110 may be received and process by PHY 456, MAC 466, and RLC 476 to obtain RLC packets from UE 110. Similarly, at booster eNB 132, the uplink signal(s) from UE 110 may be received and process by PHY 458, MAC 468, and RLC 478 to obtain RLC packets from UE 110. Booster eNB 132 may forward the RLC packets for UE 110 to anchor eNB 130. Anchor eNB 130 may aggregate the RLC packets for UE 110 obtained by eNBs 130 and 132 and may process the aggregated RLC packets for PDCP 486 to obtain data (e.g., IP packets) for UE 110. Anchor eNB 130 may send the data for UE 110 to serving gateway 146.

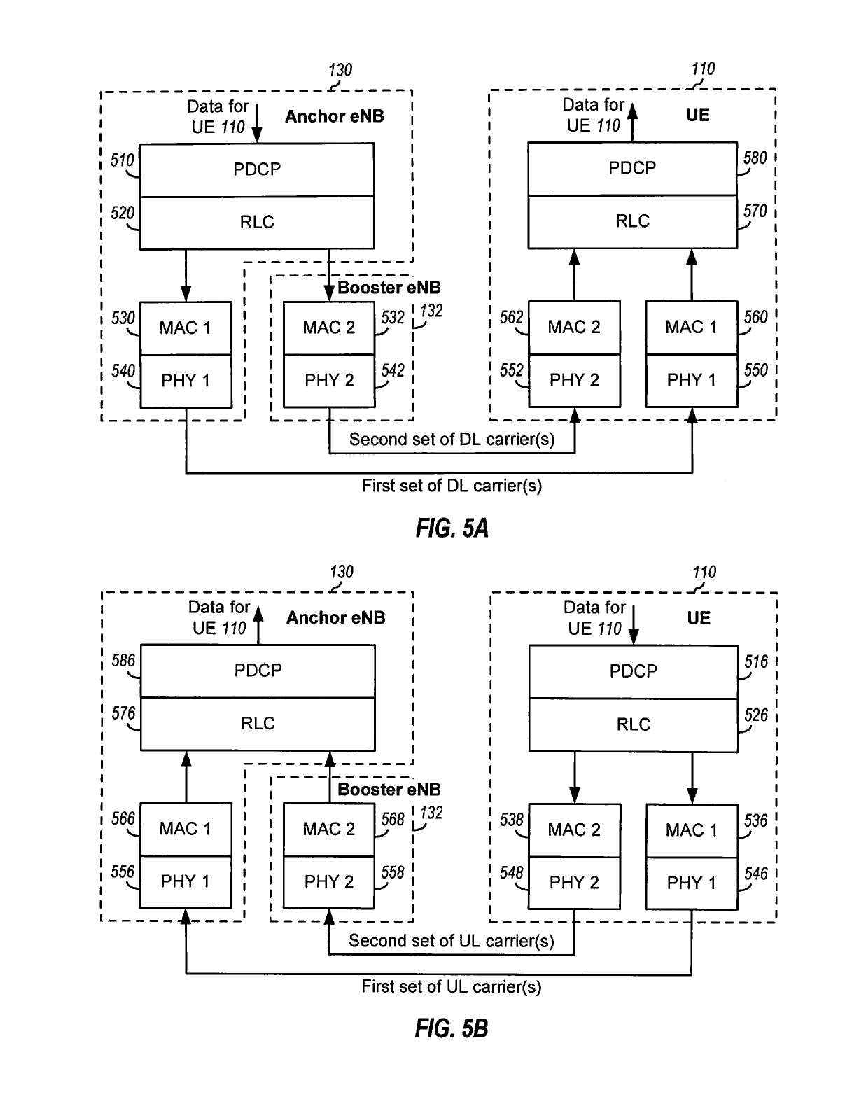

FIG. 5A shows a design of packet-level splitting at RLC layer for downlink data transmission. Anchor eNB 130 may receive data (e.g., IP packets) for UE 110 (e.g., for a data bearer configured for UE 110). Anchor eNB 130 may process the received data for PDCP 510 and RLC 520 and generate RLC packets (e.g., RLC PDUs). Anchor eNB 130 may perform packet-level splitting and may determine a first set of RLC packets to transmit directly to UE 110 and a second set of RLC packets to forward to booster eNB 132 for transmission to UE 110. Anchor eNB 130 may process the first set of RLC packets for MAC 530 and PHY 540 and may generate one or more downlink signals comprising the first set of RLC packets sent on a first set of downlink carriers configured for UE 110 at eNB 130. Anchor eNB 130 may forward the second set of RLC packets to booster eNB 132. Anchor eNB 130 may pre-pack or segment RLC packets forwarded to booster eNB. Booster eNB 132 may process the second set of RLC packets for MAC 532 and PHY 542 and may generate one or more downlink signals comprising the second set of RLC packets sent on a second set of downlink carriers configured for UE 110 at eNB 132.

At UE 110, the downlink signal(s) from anchor eNB 130 may be received and process by PHY 550 and MAC 560 to obtain MAC packets (e.g., MAC SDUs) from eNB 130. Similarly, the downlink signal(s) from booster eNB 132 may be received and process by PHY 552 and MAC 562 to obtain MAC packets from eNB 132. UE 110 may aggregate the MAC packets from eNBs 130 and 132, process the aggregated MAC packets for RLC 570 and PDCP 580, and provide data (e.g., IP packets) sent to UE 110.

FIG. 5B shows a design of packet-level splitting at RLC layer for uplink data transmission. UE 110 may receive data (e.g., IP packets) to send on the uplink (e.g., for a data bearer configured for UE 110). UE 110 may process the received data for PDCP 516 and RLC 520 and generate RLC packets. UE 110 may perform packet-level splitting and may determine a first set of RLC packets to transmit to anchor eNB 130 and a second set of RLC packets to transmit to booster eNB 132. UE 110 may process the first set of RLC packets for MAC 536 and PHY 546. UE 110 may also process the second set of RLC packets for MAC 538 and PHY 548. UE 110 may generate one or more uplink signals comprising (i) the first set of RLC packets sent on a first set of uplink carriers configured for UE 110 at eNB 130 and (ii) the second set of RLC packets sent on a second set of uplink carriers configured for UE 110 at eNB 132.

At anchor eNB 130, the uplink signal(s) from UE 110 may be received and process by PHY 556 and MAC 566 to obtain MAC packets (e.g., MAC SDUs) from UE 110. Similarly, at booster eNB 132, the uplink signal(s) from UE 110 may be received and process by PHY 558 and MAC 568 to obtain MAC packets from UE 110. Booster eNB 132 may forward the MAC packets for UE 110 to anchor eNB 130. Anchor eNB 130 may aggregate the MAC packets for UE 110 obtained by eNBs 130 and 132 and may process the aggregated MAC packets for RLC 576 and PDCP 586 to obtain data (e.g., IP packets) for UE 110. Anchor eNB 130 may send the data for UE 110 to serving gateway 146.

As shown in FIGS. 5A and 5B, packet-level splitting at RLC may have the following features. eNB 130 may have a common RLC for both eNBs 130 and 132 for data transmission on the downlink, e.g., similar to carrier aggregation. UE 110 may have a common RLC for both eNBs 130 and 132 for data transmission on the uplink. Each eNB may have its own independent MAC and PHY for UE 110. No changes to core network 140 may be needed to support packet-level splitting at RLC layer. Data to be sent on the downlink to UE 110 may be received at anchor eNB 130, which may process the data to generate RLC PDUs and may split these RLC PDUs into multiple streams of RLC PDUs for multiple eNBs. Anchor eNB 130 may forward RLC PDUs for UE 110 to other eNBs via a proprietary interface or an open interface between eNBs, which may support data transport and flow control needed to efficiently serve UE 110.

Packet-level splitting at RLC layer may provide certain advantages. First, a common RLC at anchor eNB 130 may provide flexibility in determining how large RLC SDUs can be segmented to RLC PDUs depending on the link status of each eNB, assuming anchor eNB 130 is aware of the link status of booster eNB 132. Second, the common RLC at anchor eNB 130 may enable re-transmissions of RLC packets via either eNB 130 or 132, which may benefit from instantaneously better and/or less loaded cell. RLC PDUs may arrive at UE 110 in a different order. Timers for RLC PDUs may be set to appropriate values in order to avoid unnecessary retransmissions. The timers should not be too short due to variable packet delay through different eNBs. The timers should also not be too long since an RLC PDU may indeed have been lost and long timers may lead to performance degradation.

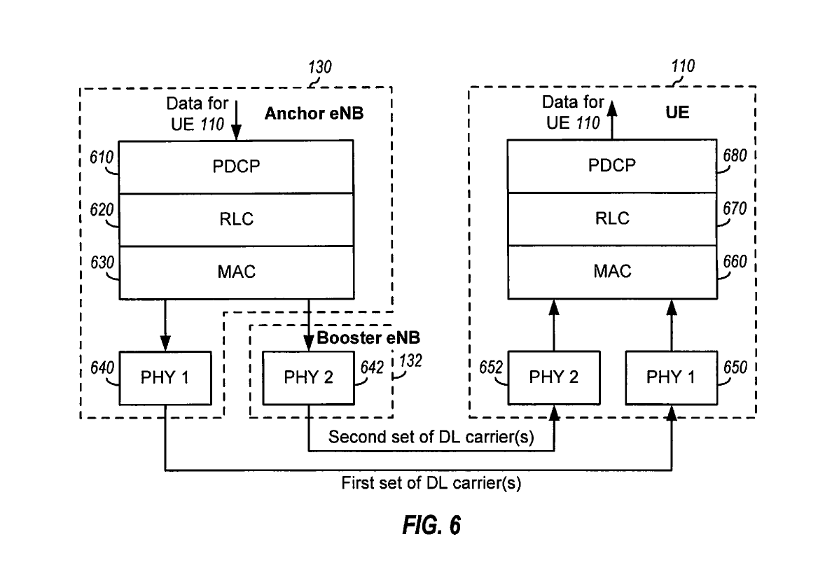

FIG. 6 shows a design of packet-level splitting at MAC layer for downlink data transmission. Anchor eNB 130 may receive data (e.g., IP packets) for UE 110 (e.g., for a data bearer configured for UE 110). Anchor eNB 130 may process the received data for PDCP 610, RLC 620, and MAC 630 and generate MAC packets (e.g., MAC PDUs). Anchor eNB 130 may perform packet-level splitting and may determine a first set of MAC packets to transmit directly to UE 110 and a second set of MAC packets to forward to booster eNB 132 for transmission to UE 110. Anchor eNB 130 may process the first set of MAC packets for PHY 640 and may generate one or more downlink signals comprising the first set of MAC packets sent on a first set of downlink carriers configured for UE 110 at eNB 130. Anchor eNB 130 may forward the second set of MAC packets to booster eNB 132. Booster eNB 132 may process the second set of MAC packets for PHY 642 and may generate one or more downlink signals comprising the second set of MAC packets sent on a second set of downlink carriers configured for UE 110 at eNB 132.

At UE 110, the downlink signal(s) from anchor eNB 130 may be received and process by PHY 650 to obtain PHY packets from eNB 130. Similarly, the downlink signal(s) from booster eNB 132 may be received and process by PHY 652 to obtain PHY packets from eNB 132. UE 110 may aggregate the PHY packets from eNBs 130 and 132, process the aggregated PHY packets for MAC 660, RLC 670 and PDCP 680, and provide data (e.g., IP packets) sent to UE 110.

Packet-level splitting at MAC layer for uplink data transmission may be performed in similar manner as for downlink data transmission. For data transmission on the downlink, MAC 630 may receive HARQ feedback for MAC packets sent via eNBs 130 and 132 and may schedule retransmission of MAC packets received in error by UE 110. For data transmission on the uplink, MAC at UE 110 may receive HARQ feedback for MAC packets sent to eNBs 130 and 132 and may schedule retransmission of MAC packets received in error by eNB 130 or 132.

FIGS. 4A to 6 show data for UE 110 being split at packet level with PDCP, RLC, or MAC aggregation. In one design, the data provided to PDCP (e.g., at eNB 130 or UE 110) in FIGS. 4A to 6 may correspond to one data bearer/EPS bearer for UE 110. UE 110 may have multiple data bearers. In one design, the processing shown in FIG. 4A, 4B, 5A, 5B or 6 may be replicated K times for K data bearers, and the data for each data bearer may be processed as shown in FIG. 4A, 4B, 5A, 5B or 6. In another design, data for more than one data bearer may be processed as shown in FIG. 4A, 4B, 5A, 5B or 6.

Table 1 summarizes various characteristics of packet-level splitting at PDCP and RLC for the exemplary designs shown in FIGS. 4A to 5B.

TABLE 1
Packet-Level Splitting

| Evaluation | Common RLP/ | Common PDCP/ |
|---|---|---|
| criteria | RLP Level Aggregation | PDCP Level Aggregation |
| Impact to | None | None |
| core network | | |
| Anchor eNB | Forward downlink RLC SDUs to | Forward downlink PDCP SDUs to |
| data plane | booster eNB. | booster eNB. |
| functions | Receive uplink RLC SDUs from | Receive uplink PDCP SDUs from |
| | booster eNB. | booster eNB. |
| | Perform re-ordering and duplicate | Perform re-ordering and duplicate |
| | detection at RLC layer (as already | detection at PDCP layer. |
| | defined). | |
| Booster | Receive downlink RLC SDUs | Receive downlink PDCP SDUs |
| eNB | from anchor eNB and pack into | from anchor eNB and form RLC |
| data plane | MAC SDUs plus padding to serve | SDUs to serve UE. |
| functions | UE. | Receive uplink PDCP SDUs from |
| | Receive uplink RLC SDUs from | UE and forward to anchor eNB. |
| | UE and forward to anchor eNB. | |
| Anchor - | Control plane plus RLC | Control plane plus PDCP |
| booster | forwarding from anchor eNB and | forwarding from anchor eNB and |
| interface | booster eNB | booster eNB. |
| | Possible time constraints on | |
| | interface for RLC feedback. | |
| Routing | Same as for X2-U with higher | Same as for X2-U with slightly |
| efficiency | overhead. | higher overhead. |
| Security | All security at anchor eNB. | All security at anchor eNB. |
| | Booster eNB does not see any | Booster eNB does not see any |
| | unencrypted content on the data | unencrypted content on the data |
| | plane. | plane. |

In LTE Release 10, UE 110 may send uplink control information (UCI) to a single cell, which may be the primary cell for UE 110. The UCI may include acknowledgement/negative acknowledgement (ACK/NACK) for downlink data transmission, channel state information (CSI) reported periodically, etc. When aggregation is done at lower layers (e.g., RLC or MAC), it may possible to preserve this concept and have UE 110 send UCI on a single Physical Uplink Control Channel (PUCCH) to the primary cell.

UE 110 may communicate with the primary cell and one or more additional cells, with each additional cell being referred to as a secondary cell for UE 110. The primary cell and a secondary cell may utilize different radio access technologies (RATs). For example, the primary cell may utilize LTE, and the secondary cell may utilize Wi-Fi.

In one deign, a non-LTE secondary cell may be considered as an LTE secondary cell from the perspective of UCI to send for the non-LTE cell. A feedback payload of a non-LTE RAT may be adjusted appropriately to match existing LTE control formats. Furthermore, UCI may be sent based on the timelines of different RATs to allow for undisturbed operation. The problems and solutions may be RAT dependent and may be addressed separately for each RAT (e.g. Wi-Fi, HSPA, etc.) to obtain good performance.

In another design, a non-LTE secondary cell may be considered as a new type of secondary cell from the perspective of UCI to send for the non-LTE cell. UCI may be sent in various manners in this design. For example, independent uplink operation may be allowed among aggregated cells for carrier aggregation. As another example, a single PUCCH may carry UCI for one or more LTE cells, and a Physical Uplink Shared Channel (PUSCH) may carry UCI for one or more non-LTE cells.

In LTE Release 10, different cells may independently send downlink control information (DCI) to UE 110. The DCI may include downlink grants, uplink grants, ACK/NACK for uplink data transmission, etc. This concept may be extended to carrier aggregation, and multiple cells supporting carrier aggregation for UE 110 may separately send DCI to UE 110. The only impact may be related to cross-carrier control that may require interpretation of this command for non-LTE cells (that potentially do not support this functionality originally).

In LTE Release 10, a single MAC PDU can activate/deactivate one or more secondary cells at a time. This functionality may be limited to only LTE cells or may be extended to non-LTE cells. If this functionality is applicable to all cells, then rules may be established regarding behavior and timing of cell activation/deactivation, e.g., follow LTE rules (which may not always be feasible in terms of timing), or follow rules of non-LTE cells (if activation/deactivation feature is defined), in which case MAC in LTE may be modified to support these rules.

In LTE Release 10, new cell configuration may be provided by the primary cell and may include all pertinent system information so that UE 110 does not need to read system information blocks (SIBs) of secondary cells. The same concept may be extended to carrier aggregation. Alternatively, if downlink operation is decoupled, then this functionality may be decoupled as well, and UE 110 may decide whether or not to read system information directly from non-LTE secondary cells.

UE 110 may perform random access via only the primary cell in LTE Release 10 and also via a secondary cell when order by a wireless network in LTE Release 11. If UE 110 can communicate with only one cell on the uplink, then random access may be limited to only the primary cell. Alternatively, if UE 110 can communicate with multiple cells (which may include at least one non-LTE cell) on the uplink, then a random access procedure defined for a non-LTE RAT may be allowed.

UE 110 may be configured with multiple downlink carriers and/or multiple uplink carriers for carrier aggregation. Furthermore, UE 110 may communicate with multiple eNBs for carrier aggregation. In one design, UE 110 may communicate with each eNB on a set of one or more downlink carriers and a set of one or more uplink carriers configured for UE 110 at that eNB. For example, UE 110 may communicate with anchor eNB 130 on a first set of downlink carrier(s) and a first set of uplink carrier(s) and may communicate with booster eNB 132 on a second set of downlink carrier(s) and a second set of uplink carrier(s). In one design, for each link, the first set of carrier(s) for anchor eNB 130 may be non-overlapping with the second set of carrier(s) for booster eNB 132. In this design, UE 110 may communicate with only one eNB 130 or 132 on each carrier. In another design, for each link, the first set of carrier(s) may be overlapping with the second set of carrier(s). In this design, UE 110 may communicate with both eNBs 130 and 132 on one carrier and may communicate with only eNB 130 or 132 on another carrier. In general, UE 110 may be configured with overlapping or non-overlapping sets of carriers for multiple eNBs for each link.

A flow may refer to a stream of packets sent via one eNB (e.g., for one data bearer) for a UE. In the designs shown in FIGS. 4A to 6, there may be two flows for UE 110 at two eNBs 130 and 132, one flow at each eNB. In one design, for flow-to-carrier mapping, a flow for a UE at an eNB may be mapped to a set of one or more carriers configured for the UE at the eNB. This flow-to-carrier mapping may be applicable regardless of whether aggregation is at PDCP layer as shown in FIGS. 4A and 4B, or at RLC layer as shown in FIGS. 5A and 5B, or at MAC layer as shown in FIG. 6.

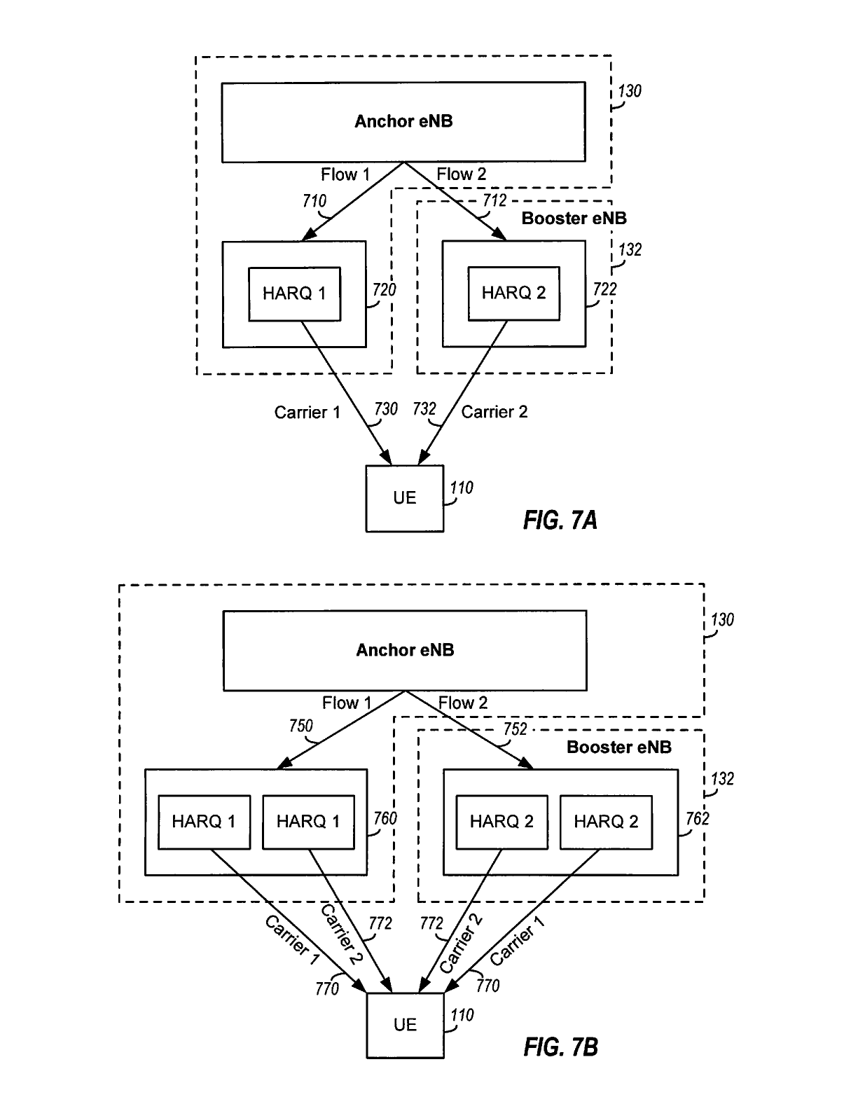

FIG. 7A shows an example of flow-to-carrier mapping for downlink data transmission to UE 110 on non-overlapping sets of carriers at two eNBs 130 and 132. In this example, UE 110 has a first flow 710 via anchor eNB 130 and a second flow 712 via booster eNB 132. UE 110 is also configured with a first downlink carrier 730 at anchor eNB 130 and with a second downlink carrier 732 at booster eNB 132. In the example shown in FIG. 7A, the first flow 710 is mapped to the first carrier 730 at anchor eNB 130. The second flow 712 is mapped to the second carrier 732 at booster eNB 132.

FIG. 7A shows a design in which each flow is mapped to one exclusive carrier at one eNB. An exclusive carrier is a carrier that is used by only one eNB for a UE. UE 110 may be connected via multiple carriers at different eNBs and to only one eNB on each carrier. In general, a flow may be mapped to any number of carriers at a given eNB. Different flows may be mapped to the same number of carriers or different numbers of carriers. For example, the first flow 710 may be mapped to M carriers and the second flow 712 may be mapped to N subcarriers, where M 1 and N 1. Any number of UEs may use a given/same carrier for their flows.

FIG. 7B shows an example of flow-to-carrier mapping for downlink data transmission to UE 110 on overlapping sets of carriers at two eNBs 130 and 132. In this example, UE 110 has a first flow 750 via anchor eNB 130 and a second flow 752 via booster eNB 132. UE 110 is also configured with two downlink carriers 770 and 772 at anchor eNB 130 and with the same downlink carriers 770 and 772 at booster eNB 132. In the example shown in FIG. 7B, the first flow 750 is mapped to the two carriers 770 and 772 at anchor eNB 130. The second flow 752 is also mapped to the same two carriers 770 and 772 at booster eNB 132.

FIG. 7B shows a design in which each flow is mapped to shared carriers at one eNB. A shared carrier is a carrier that is used by multiple eNBs for a UE. UE 110 may be connected to multiple carriers at different eNBs and may receive from (thus, may be connected to) multiple eNBs on a given carrier, e.g., in time division multiplexed (TDM) or frequency division multiplexed (FDM) manner.

The designs in FIGS. 7A and 7B may be used for eNBs of the same type, e.g., macro eNBs. These designs may also be used for eNBs of different types (e.g., a macro eNB and a home eNB), which may operate in different frequency spectrum and/or may use different RATs. For example, these designs may be used for LTE and Wi-Fi aggregation. Mapping multiple flows at multiple eNBs on multiple overlapping or non-overlapping sets of carriers may provide more scheduling flexibility and better load balancing. In general, a carrier may be used for any number of flows for a UE, and any number of carriers may be used for multiple flows. All or a subset of the carriers configured for a UE for carrier aggregation may be used for multiple flows at multiple eNBs.

In another aspect of the present disclosure, a UE may be configured with disjoint uplink and downlink data channels at different cells and may be served by these different cells on the uplink and downlink, e.g., for carrier aggregation. A first set of at least one cell may be selected to serve the UE on the downlink. The UE may be assigned a downlink data channel, e.g., a Physical Downlink Shared Channel (PDSCH), by each cell in the first set. The UE may receive downlink data transmission from each cell in the first set on the PDSCH configured for the UE at that cell. A second set of at least one cell may be selected to serve the UE on the uplink. The UE may be assigned an uplink data channel, e.g., a PUSCH, by each cell in the second set. The UE may send uplink data transmission to any cell in the second set on the PUSCH configured for the UE at that cell.

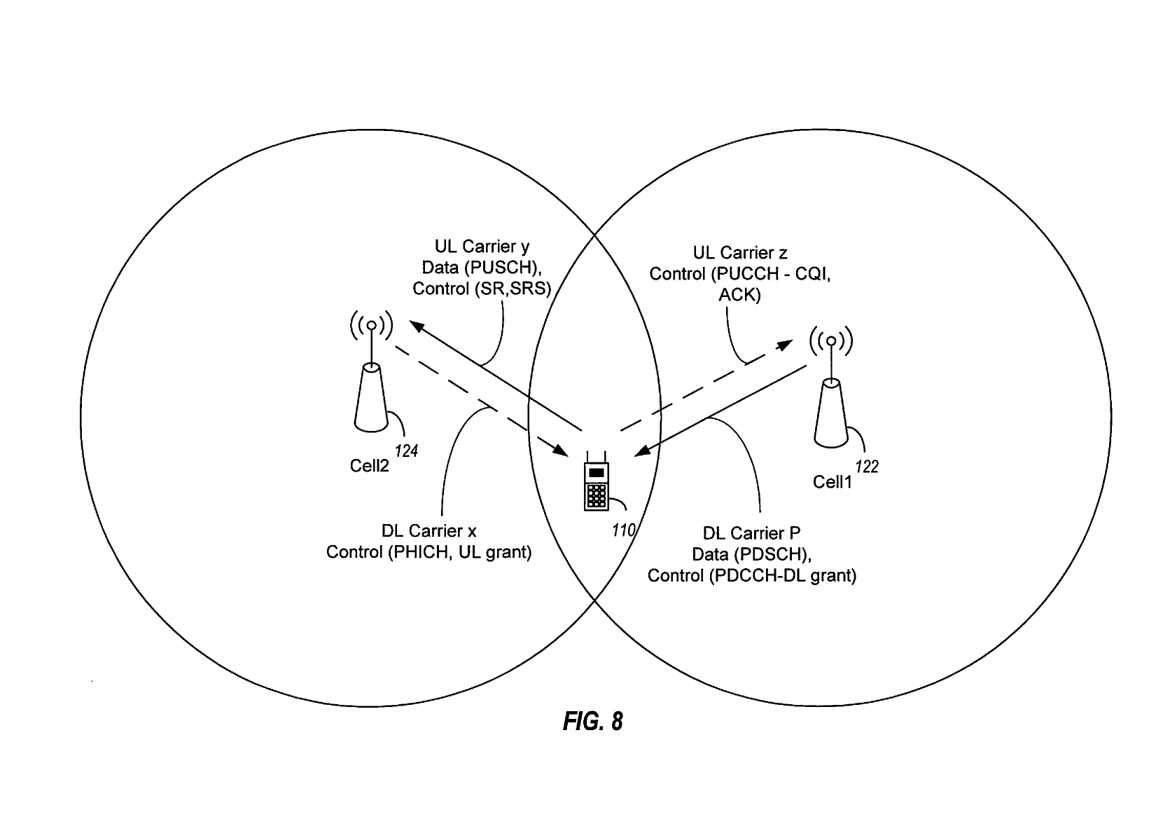

FIG. 8 shows a design of disjoint uplink and downlink data channels at two cells 122 and 124 for UE 110. Cell 122 may be selected to serve UE 110 on the downlink. Cell 124 may be selected to serve UE 110 on the uplink. Each cell may be selected to serve UE 110 on a given link based on various criteria such as channel conditions, cell loading, etc. In one design, cells 122 and 124 may be part of the same eNB, e.g., anchor eNB 130. In another design, cells 122 and 124 may be part of different eNBs, e.g., anchor eNB 130 and booster eNB 132.

In the design shown in FIG. 8, UE 110 may be configured with a PDSCH, a Physical Downlink Control Channel (PDCCH), and a PUCCH for cell 122. UE 110 may also be configured with a PUSCH, a PDCCH, and a Physical HARQ Indictor Channel (PHICH) for cell 124. UE 110 may be configured with any number of downlink carriers for cell 122 and with any number of uplink carriers for cell 124.

In one design, cell 122 may support the following physical channels for UE 110:
PDSCH—carry downlink data from cell 122 to UE 110,
PDCCH—carry downlink scheduling from cell 122 to UE 110, and
PUCCH—carry ACK/NACK and CSI feedback from UE 110 to cell 122.

In one design, cell 124 may support the following physical channels for UE 110:
PUSCH—carry uplink data, scheduling request (SR), and sounding reference signal (SRS) from UE 110 to cell 124,
PDCCH—carry uplink scheduling from cell 124 to UE 110, and
PHICH—carry ACK/NACK from cell 124 to UE 110 for uplink data transmission on the PUSCH.

UE 110 may not be configured with a PUSCH for cell 122. UE 110 may send measurement reports for cell 122 on the PUCCH to cell 122, or on the PUSCH to cell 124, or via some other mechanism.

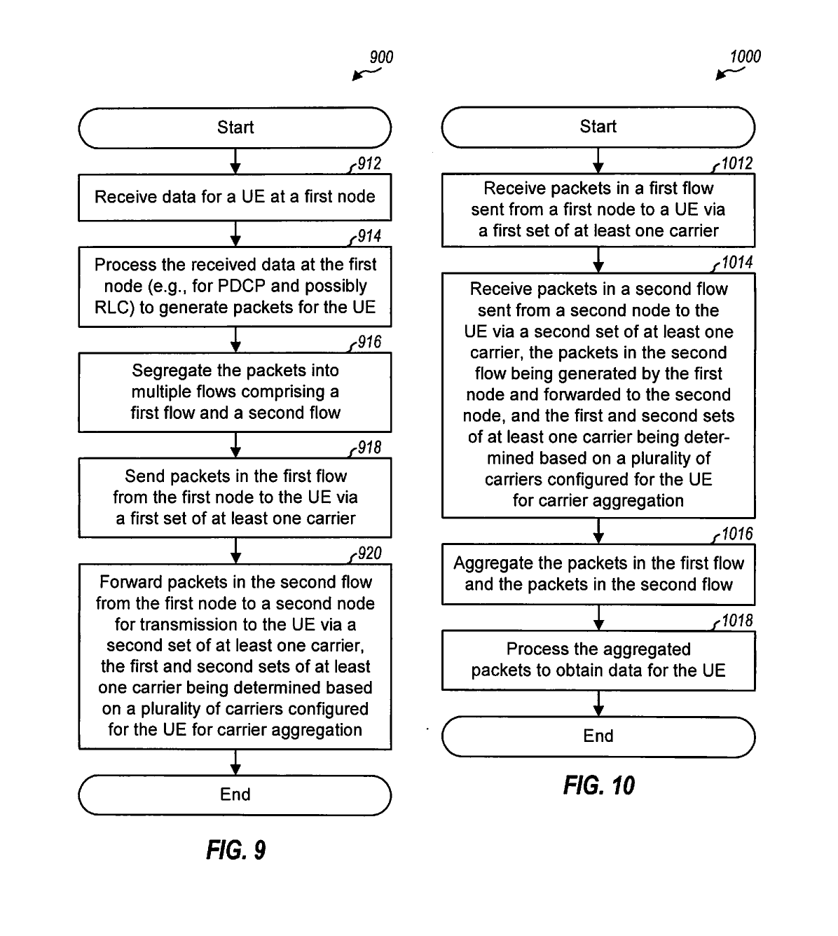

FIG. 9 shows a design of a process 900 for sending data in a wireless network. Process 900 may be performed by a first node, which may be a base station, a relay, or some other entity. The first node may receive data for a UE, e.g., from a serving gateway (block 912). The first node may process the received data at the first node to generate packets for the UE (block 914). The first node may segregate the packets into multiple flows comprising a first flow and a second flow (block 916). The first node may send packets in the first flow to the UE via a first set of at least one carrier (block 918). The first node may forward packets in the second flow to a second node for transmission to the UE via a second set of at least one carrier (block 920).

The UE may be configured with a plurality of carriers for carrier aggregation. The first and second sets of at least one carrier may be determined based on the plurality of carriers configured for the UE. For example, the first and second sets may correspond to different subsets of the plurality of carriers configured for the UE. In one design, the first and second sets may be non-overlapping and may include distinct carriers, with no carrier the first set being included the second set. In another design, the first and second sets may overlap and may include at least one common carrier that is present in both the first set and the second set. In yet another design, the first set may be the same as the second set, e.g., as shown in FIG. 7B. For all designs, the first node may determine resources, on the first set of at least one carrier, to use to send the packets in the first flow to the UE based on a configuration applicable for the first flow, or the UE, or both.

In one design, aggregation at PDCP layer may be supported, e.g., as shown in FIG. 4A. For blocks 914 to 920, the first node may process the received data for PDCP to generate PDCP packets for the UE. The first node may process PDCP packets in the first flow for RLC, MAC, and PHY to generate at least one downlink signal comprising the PDCP packets in the first flow mapped to the first set of at least one carrier. The first node may forward PDCP packets in the second flow to the second node.

In another design, aggregation at RLC layer may be supported, e.g., as shown in FIG. 5A. For blocks 914 to 920, the first node may process the received data for PDCP and RLC to generate RLC packets for the UE. The first node may process RLC packets in the first flow for MAC and PHY to generate at least one downlink signal comprising the RLC packets in the first flow mapped to the first set of at least one carrier. The first node may forward RLC packets in the second flow to the second node.

In one design, first and second nodes may correspond to two base stations in a WAN. In another design, the first node may correspond to a base station in a WAN, and the second node may correspond to an access point in a WLAN. The first and second nodes may also correspond to other entities.

FIG. 10 shows a design of a process 1000 for receiving data in a wireless network. Process 1000 may be performed by a UE, as described below, or by some other entity. The UE may receive packets in a first flow sent from a first node to the UE via a first set of at least one carrier (block 1012). The UE may also receive packets in a second flow sent from a second node to the UE via a second set of at least one carrier (block 1014). The packets in the second flow may be generated by the first node and forwarded to the second node. The UE may be configured with a plurality of carriers for carrier aggregation. The first and second sets of at least one carrier may be determined based on the plurality of carriers configured for the UE. The UE may aggregate the packets in the first flow and the packets in the second flow (block 1016). The UE may process the aggregated packets to obtain data for the UE (block 1018).

In one design, aggregation at PDCP layer may be supported, e.g., as shown in FIG. 4A. For blocks 1012 to 1018, the UE may process at least one first downlink signal from the first node for PHY, MAC, and RLC to obtain RLC packets in the first flow. The UE may also process at least one second downlink signal from the second node for PHY, MAC, and RLC to obtain RLC packets in the second flow. The aggregated packets may comprise RLC packets. The UE may process the RLC packets for PDCP to obtain the data for the UE.

In another design, aggregation at RLC layer may be supported, e.g., as shown in FIG. 5A. For blocks 1012 to 1018, the UE may process at least one first downlink signal from the first node for PHY and MAC to obtain MAC packets in the first flow. The UE may also process at least one second downlink signal from the second node for PHY and MAC to obtain MAC packets in the second flow. The aggregated packets may comprise MAC packets. The UE may process the MAC packets, for RLC and PDCP to obtain the data for the UE.

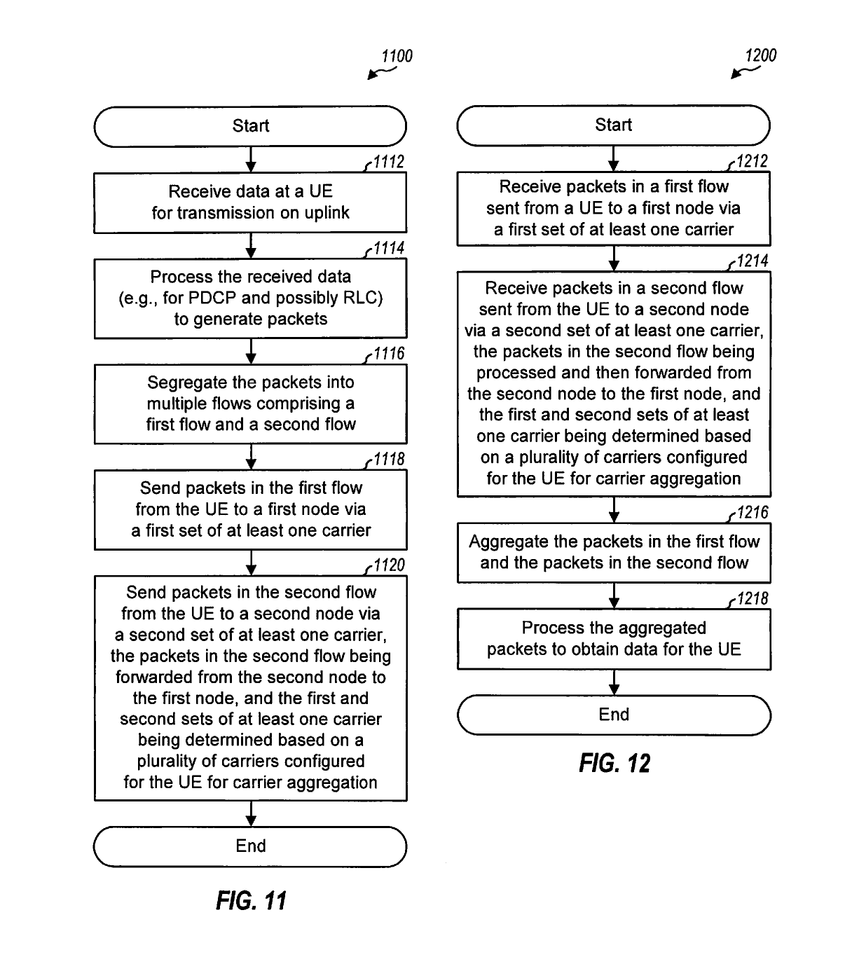

FIG. 11 shows a design of a process 1100 for sending data in a wireless network. Process 1100 may be performed by a UE, as described below, or by some other entity. The UE may receive data for transmission on the uplink (block 1112). The UE may process the received data to generate packets (block 1114). The UE may segregate the packets into multiple flows comprising a first flow and a second flow (block 1116). The UE may send packets in the first flow to a first node via a first set of at least one carrier (block 1118). The UE may send packets in the second flow to a second node via a second set of at least one carrier (block 1120). The packets in the second flow may be forwarded from the second node to the first node. The UE may be configured with a plurality of carriers for carrier aggregation. The first and second sets of at least one carrier may be determined based on (e.g., may correspond to different subsets of) the plurality of carriers configured for the UE.

In one design, aggregation at PDCP layer may be supported, e.g., as shown in FIG. 4B. For blocks 1114 to 1120, the UE may process the received data for PDCP to generate PDCP packets and may segregate the PDCP packets into PDCP packets in the first flow and PDCP packets in the second flow. The UE may process the PDCP packets in the first flow for RLC, MAC, and PHY to generate at least one uplink signal comprising the PDCP packets in the first flow mapped to the first set of at least one carrier. The UE may also process the PDCP packets in the second flow for RLC, MAC, and PHY to generate the at least one uplink signal comprising the PDCP packets in the second flow mapped to the second set of at least one carrier.

In one design, aggregation at RLC layer may be supported, e.g., as shown in FIG. 5B. For blocks 1114 to 1120, the UE may process the received data for PDCP and RLC to generate RLC packets. The UE may segregate the RLC packets into RLC packets in the first flow and RLC packets in the second flow. The UE may process the RLC packets in the first flow for MAC and PHY to generate at least one uplink signal comprising the RLC packets in the first flow mapped to the first set of at least one carrier. The UE may process the RLC packets in the second flow for MAC and PHY to generate the at least one uplink signal comprising the RLC packets in the second flow mapped to the second set of at least one carrier.

FIG. 12 shows a design of a process 1200 for receiving data in a wireless network. Process 1200 may be performed by a first node, which may be a base station, a relay, or some other entity. The first node may receive packets in a first flow sent from a UE to the first node via a first set of at least one carrier (block 1212). The first node may receive packets in a second flow sent from the UE to a second node via a second set of at least one carrier (block 1214). The packets in the second flow may be processed and then forwarded from the second node to the first node. The UE may be configured with a plurality of carriers for carrier aggregation. The first and second sets of at least one carrier may be determined based on the plurality of carriers configured for the UE. The first node may aggregate the packets in the first flow and the packets in the second flow (block 1216). The first node may process the aggregated packets to obtain data for the UE (block 1218).

In one design, aggregation at PDCP layer may be supported, e.g., as shown in FIG. 4B. For blocks 1212 to 1218, the first node may process at least one uplink signal from the UE for PHY, MAC, and RLC to obtain RLC packets in the first flow. The aggregated packets may comprise RLC packets. The first node may process the RLC packets for PDCP to obtain the data for the UE.

In another design, aggregation at RLC layer may be supported, e.g., as shown in FIG. 5B. For blocks 1212 to 1218, the first node may process at least one uplink signal from the UE for PHY and MAC to obtain MAC packets in the first flow. The aggregated packets may comprise MAC packets. The first node may process the MAC packets for RLC and PDCP to obtain the data for the UE.

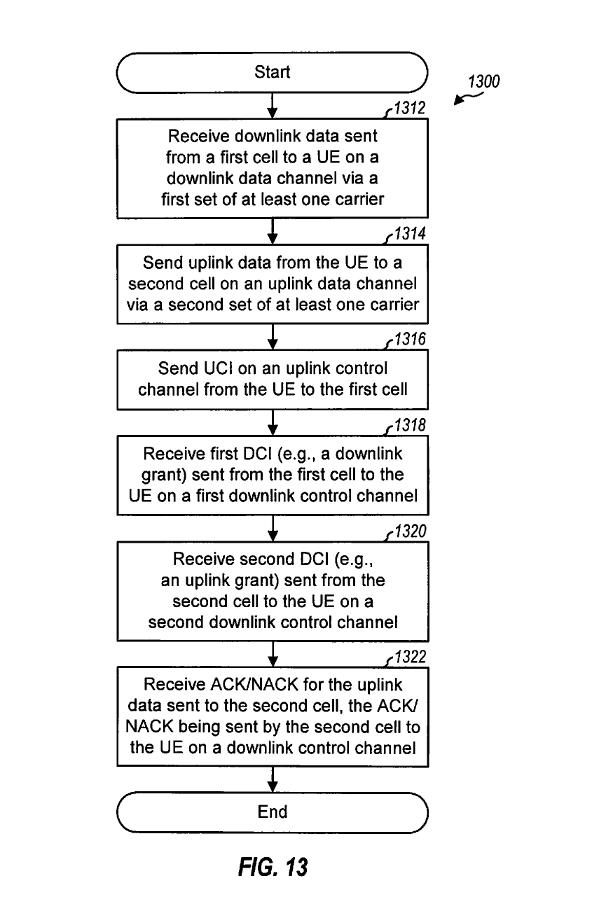

FIG. 13 shows a design of a process 1300 for sending data in a wireless network. Process 1300 may be performed by a UE, as described below, or by some other entity. The UE may receive data sent from a first cell to the UE on a downlink data channel (e.g., a PDSCH) via a first set of at least one carrier (block 1312). The UE may send uplink data to a second cell on an uplink data channel (e.g., a PUSCH) via a second set of at least one carrier (block 1314). The UE may not be configured with a downlink data channel for the second cell.

The first set of at least one carrier may be different from, or the same as, the second set of at least one carrier. In one design, the UE may be configured with a plurality of carriers for carrier aggregation. The first and second sets of at least one carrier may be determined based on (e.g., may correspond to different subsets of) the plurality of carriers configured for the UE. For example, each of the plurality of carriers may be included in at most one of the first and second sets of at least one carrier.

The UE may send UCI on an uplink control channel (e.g., a PUCCH) to the first cell (block 1316). The UCI may comprise ACK/NACK for the downlink data received from the first cell and/or CSI.

In one design, the UE may receive first DCI sent from the first cell to the UE on a first downlink control channel (e.g., a first PDCCH) (block 1318). The first DCI may comprise a downlink grant scheduling the UE for downlink data transmission on the downlink data channel. The UE may receive second DCI sent from the second cell to the UE on a second downlink control channel (block 1320). The second DCI may comprise an uplink grant scheduling the UE for uplink data transmission on the uplink data channel. The VE may receive ACK/NACK for the uplink data sent to the second cell, with the ACK/NACK being sent by the second cell to the UE on a downlink control channel (e.g., a PHICH) (block 1322).

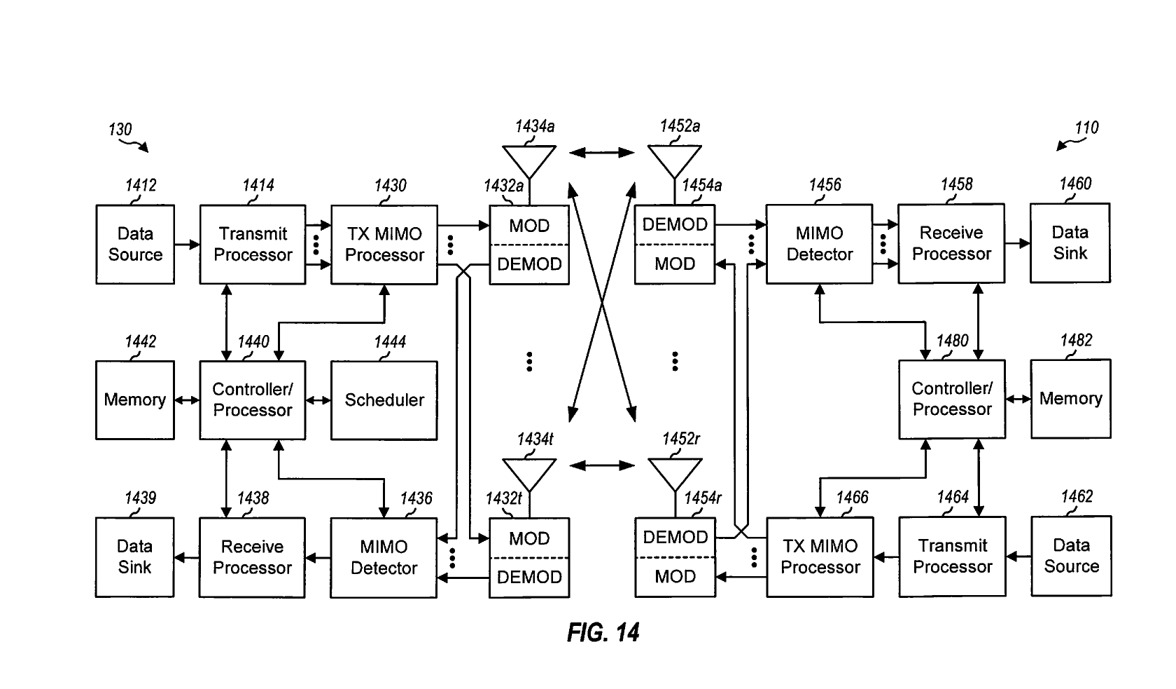

FIG. 14 shows a block diagram of an exemplary design of UE 110 and eNB/base station 130 in FIG. 1. eNB 130 may be equipped with T antennas 1434a through 1434t, and UE 110 may be equipped with R antennas 1452a through 1452r, where in general T≧1 and R≧1.

At eNB 130, a transmit processor 1420 may receive data for one or more UEs from a data source 1412 and control information from a controller/processor 1440. Data source 1412 may implement one or more data buffers for UE 110 and other UEs served by eNB 130. The control information may comprise downlink grants, uplink grants, ACK/NACK, configuration messages, etc. Transmit processor 1420 may process (e.g., encode, interleave, and symbol map) the data and control information to obtain data symbols and control symbols, respectively. Transmit processor 1420 may also generate reference symbols for one or more reference signals. A transmit (TX) multiple-input multiple-output (MIMO) processor 1430 may perform spatial processing (e.g., precoding) on the data symbols, the control symbols, and/or the reference symbols, if applicable, and may provide T output symbol streams to T modulators (MODs) 1432a through 1432t. Each modulator 1432 may process a respective output symbol stream (e.g., for OFDM, SC-FDMA, CDMA, etc.) to obtain an output sample stream. Each modulator 1432 may further process (e.g., convert to analog, amplify, filter, and upconvert) the output sample stream to obtain an uplink signal. T uplink signals from modulators 1432a through 1432t may be transmitted via T antennas 1434a through 1434t, respectively.

At UE 110, antennas 1452a through 1452r may receive the downlink signals from eNB 130 and other eNBs and may provide received signals to demodulators (DEMODs) 1454a through 1454r, respectively. Each demodulator 1454 may condition (e.g., filter, amplify, downconvert, and digitize) a respective received signal to obtain received samples. Each demodulator 1454 may further process the received samples to obtain received symbols. A MIMO detector 1456 may obtain received symbols from all R demodulators 1454a through 1454r and may perform MIMO detection on the received symbols to obtain detected symbols. A receive processor 1458 may process (e.g., symbol demap, deinterleave, and decode) the detected symbols, provide decoded data to a data sink 1460, and provide decoded control information to a controller/processor 1480.

On the uplink, at UE 110, data from a data source 1462 and control information (e.g., ACK/NACK, CSI, etc.) from controller/processor 1480 may be processed by a transmit processor 1464, precoded by a TX MIMO processor 1466 if applicable, conditioned by modulators 1454a through 1454r, and transmitted to eNB 130 and other eNBs. At eNB 130, the uplink signals from UE 110 and other UEs may be received by antennas 1434, conditioned by demodulators 1432, processed by a MIMO detector 1436, and further processed by a receive processor 1438 to obtain the data and control information sent by UE 110 and other UEs. Processor 1438 may provide the decoded data to a data sink 1439 and the decoded control information to controller/processor 1440.

Controllers/processors 1440 and 1480 may direct the operation at eNB 130 and UE 110, respectively. Memories 1442 and 1482 may store data and program codes for eNB 130 and UE 110, respectively. A scheduler 1444 may schedule UE 110 and other UEs for data transmission on the downlink and uplink and may assign resources to the scheduled UEs. Processor 1440 and/or other processors and modules at eNB 130 may perform or direct the operation performed by eNB 130 in FIGS. 4A to 8, process 900 in FIG. 9, process 1200 in FIG. 12, and/or other processes for the techniques described herein. Processor 1480 and/or other processors and modules at UE 110 may perform or direct the operation of UE 110 in FIGS. 4A to 8, process 1000 in FIG. 10, process 1100 in FIG. 11, process 1300 in FIG. 13, and/or other processes for the techniques described herein.

eNB 132 may be implemented in similar manner as eNB 130. One or more processors and/or modules at eNB 132 may perform or direct the operation performed by eNB 132 in FIGS. 4A to 8, processes 900 and 1200, and/or other processes for the techniques described herein.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication, comprising:
receiving data for a user equipment (UE) at a first node;
processing the received data at the first node to generate packets for the UE;
segregating the packets into multiple flows comprising a first flow and a second flow;
sending packets in the first flow from the first node to the UE via a first set of at least one carrier; and
forwarding packets in the second flow from the first node to a second node for transmission to the UE via a second set of at least one carrier, the first and second sets of at least one carrier being determined based on a plurality of carriers configured for the UE.

2. The method of claim 1, wherein the processing the received data comprises processing the received data for Packet Data Convergence Protocol (PDCP) to generate PDCP packets for the UE, and wherein the forwarding packets in the second flow comprises forwarding PDCP packets in the second flow from the first node to the second node.

3. The method of claim 2, wherein the sending the packets in the first flow comprises processing PDCP packets in the first flow for Radio Link Control (RLC), Medium Access Control (MAC), and Physical Layer (PHY) to generate at least one downlink signal comprising the PDCP packets in the first flow mapped to the first set of at least one carrier.

4. The method of claim 1, wherein the processing the received data comprises processing the received data for Packet Data Convergence Protocol (PDCP) and Radio Link Control (RLC) to generate RLC packets for the UE, and wherein the forwarding packets in the second flow comprises forwarding RLC packets in the second flow from the first node to the second node.

5. The method of claim 4, wherein the sending the packets in the first flow comprises processing RLC packets in the first flow for Medium Access Control (MAC) and Physical Layer (PHY) to generate at least one downlink signal comprising the RLC packets in the first flow mapped to the first set of at least one carrier.

6. The method of claim 1, wherein the first set and the second set are non-overlapping and include distinct carriers, with no carrier in the first set being included in the second set.

7. The method of claim 1, wherein the first set and the second set overlap and include at least one common carrier that is present in both the first set and the second set.

8. The method of claim 1, further comprising:
determining resources, on the first set of at least one carrier, to use to send the packets in the first flow to the UE based on a configuration applicable for the first flow, or the UE, or both.

9. The method of claim 1, wherein the first node and the second node correspond to two base stations in a wide area network (WAN).

10. The method of claim 1, wherein the first node corresponds to a base station in a wide area network (WAN), and wherein the second node corresponds to an access point in a wireless local area network (WLAN).

11. An apparatus for wireless communication, comprising:
at least one processor configured to:
receive data for a user equipment (UE) at a first node;
process the received data at the first node to generate packets for the UE;
segregate the packets into multiple flows comprising a first flow and a second flow;
send packets in the first flow from the first node to the UE via a first set of at least one carrier; and
forward packets in the second flow from the first node to a second node for transmission to the UE via a second set of at least one carrier, the first and second sets of at least one carrier being determined based on a plurality of carriers configured for the UE.

12. The apparatus of claim 11, wherein the configuration of the at least one processor to process the received data comprises configuration to process the received data for Packet Data Convergence Protocol (PDCP) to generate PDCP packets for the UE, and wherein the configuration of the at least one processor to forward the packets in the second flow comprises configuration to forward PDCP packets in the second flow from the first node to the second node.

13. The apparatus of claim 12, wherein the configuration of the at least one processor to send the packets in the first flow comprises configuration to process PDCP packets in the first flow for Radio Link Control (RLC), Medium Access Control (MAC), and Physical Layer (PHY) to generate at least one downlink signal comprising the PDCP packets in the first flow mapped to the first set of at least one carrier.

14. The apparatus of claim 11, wherein the configuration of the at least one processor to process the received data comprises configuration to process the received data for Packet Data Convergence Protocol (PDCP) and Radio Link Control (RLC) to generate RLC packets for the UE, and wherein the configuration of the at least one processor to forward the packets in the second flow comprises configuration to forward RLC packets in the second flow from the first node to the second node.

15. The apparatus of claim 11, wherein the first set and the second set are non-overlapping and include distinct carriers, with no carrier in the first set being included in the second set.

16. The apparatus of claim 11, wherein the first set and the second set overlap and include at least one common carrier that is present in both the first set and the second set.

17. The apparatus of claim 11, wherein the at least one processor is further configured to determine resources, on the first set of at least one carrier, to use to send the packets in the first flow to the UE based on a configuration applicable for the first flow, or the UE, or both.

18. An apparatus for wireless communication, comprising:
means for receiving data for a user equipment (UE) at a first node;
means for processing the received data at the first node to generate packets for the UE;
means for segregating the packets into multiple flows comprising a first flow and a second flow;
means for sending packets in the first flow from the first node to the UE via a first set of at least one carrier; and
means for forwarding packets in the second flow from the first node to a second node for transmission to the UE via a second set of at least one carrier, the first and second sets of at least one carrier being determined based on a plurality of carriers configured for the UE.

19. A computer program product, comprising:
a non-transitory computer-readable medium comprising:
code for causing at least one processor to receive data for a user equipment (UE) at a first node;
code for causing the at least one processor to process the received data at the first node to generate packets for the UE;
code for causing the at least one processor to segregate the packets into multiple flows comprising a first flow and a second flow;
code for causing the at least one processor to send packets in the first flow from the first node to the UE via a first set of at least one carrier; and
code for causing the at least one processor to forward packets in the second flow from the first node to a second node for transmission to the UE via a second set of at least one carrier, the first and second sets of at least one carrier being determined based on a plurality of carriers configured for the UE.

20. A method for wireless communication, comprising:
receiving packets in a first flow sent from a first node to a user equipment (UE) via a first set of at least one carrier;
receiving packets in a second flow sent from a second node to the UE via a second set of at least one carrier, the packets in the second flow being generated by the first node and forwarded to the second node, and the first and second sets of at least one carrier being determined based on a plurality of carriers configured for the UE;
aggregating the packets in the first flow and the packets in the second flow; and
processing the aggregated packets to obtain data for the UE.

21. The method of claim 20, wherein the aggregated packets comprise Radio Link Control (RLC) packets, and wherein the processing the aggregated packets comprises processing the RLC packets for Packet Data Convergence Protocol (PDCP) to obtain the data for the UE.

22. The method of claim 21, further comprising:
processing at least one first downlink signal from the first node for Physical Layer (PHY), Medium Access Control (MAC), and RLC to obtain RLC packets in the first flow; and
processing at least one second downlink signal from the second node for PHY, MAC, and RLC to obtain RLC packets in the second flow.

23. The method of claim 20, wherein the aggregated packets comprise Medium Access Control (MAC) packets, and wherein the processing the aggregated packets comprises processing the MAC packets for Radio Link Control (RLC) and Packet Data Convergence Protocol (PDCP) to obtain the data for the UE.

24. The method of claim 23, further comprising:
processing at least one first downlink signal from the first node for Physical Layer (PHY) and MAC to obtain MAC packets in the first flow; and
processing at least one second downlink signal from the second node for PHY and MAC to obtain MAC packets in the second flow.

25. An apparatus for wireless communication, comprising:
at least one processor configured to:
receive packets in a first flow sent from a first node to a user equipment (UE) via a first set of at least one carrier;
receive packets in a second flow sent from a second node to the UE via a second set of at least one carrier, the packets in the second flow being generated by the first node and forwarded to the second node, and the first and second sets of at least one carrier being determined based on a plurality of carriers configured for the UE;
aggregate the packets in the first flow and the packets in the second flow; and
process the aggregated packets to obtain data for the UE.

26. The apparatus of claim 25, wherein the aggregated packets comprise Radio Link Control (RLC) packets, and wherein the configuration of the at least one processor to process the aggregated packets comprises configuration to process the RLC packets for Packet Data Convergence Protocol (PDCP) to obtain the data for the UE.

27. The apparatus of claim 26, wherein the at least one processor is further configured to:
process at least one first downlink signal from the first node for Physical Layer (PHY), Medium Access Control (MAC), and RLC to obtain RLC packets in the first flow; and
process at least one second downlink signal from the second node for PHY, MAC, and RLC to obtain RLC packets in the second flow.

28. The apparatus of claim 25, wherein the aggregated packets comprise Medium Access Control (MAC) packets, and wherein the configuration of the at least one processor to process the aggregated packets comprises configuration to process the MAC packets for Radio Link Control (RLC) and Packet Data Convergence Protocol (PDCP) to obtain the data for the UE.

29. The apparatus of claim 28, wherein the at least one processor is further configured to:
process at least one first downlink signal from the first node for Physical Layer (PHY) and MAC to obtain MAC packets in the first flow; and
process at least one second downlink signal from the second node for PHY and MAC to obtain MAC packets in the second flow.

30. An apparatus for wireless communication, comprising:
means for receiving packets in a first flow sent from a first node to a user equipment (UE) via a first set of at least one carrier;
means for receiving packets in a second flow sent from a second node to the UE via a second set of at least one carrier, the packets in the second flow being generated by the first node and forwarded to the second node, and the first and second sets of at least one carrier being determined based on a plurality of carriers configured for the UE;
means for aggregating the packets in the first flow and the packets in the second flow; and
means for processing the aggregated packets to obtain data for the UE.

31. A computer program product, comprising:
a non-transitory computer-readable medium comprising:
code for causing at least one processor to receive packets in a first flow sent from a first node to a user equipment (UE) via a first set of at least one carrier;
code for causing the at least one processor to receive packets in a second flow sent from a second node to the UE via a second set of at least one carrier, the packets in the second flow being generated by the first node and forwarded to the second node, and the first and second sets of at least one carrier being determined based on a plurality of carriers configured for the UE;
code for causing the at least one processor to aggregate the packets in the first flow and the packets in the second flow; and
code for causing the at least one processor to process the aggregated packets to obtain data for the UE.

32. A method for wireless communication, comprising:
receiving data at a user equipment (UE) for transmission on uplink;
processing the received data to generate packets;
segregating the packets into multiple flows comprising a first flow and a second flow;
sending packets in the first flow from the UE to a first node via a first set of at least one carrier; and
sending packets in the second flow from the UE to a second node via a second set of at least one carrier, the packets in the second flow being forwarded from the second node to the first node, and the first and second sets of at least one carrier being determined based on a plurality of carriers configured for the UE.

33. The method of claim 32, wherein the processing the received data comprises processing the received data for Packet Data Convergence Protocol (PDCP) to generate PDCP packets, and wherein the segregating the packets into multiple flows comprises segregating the PDCP packets into PDCP packets in the first flow and PDCP packets in the second flow.

34. The method of claim 33, wherein the sending the packets in the first flow comprises processing the PDCP packets in the first flow for Radio Link Control (RLC), Medium Access Control (MAC), and Physical Layer (PHY) to generate at least one uplink signal comprising the PDCP packets in the first flow mapped to the first set of at least one carrier, and wherein the sending the packets in the second flow comprises processing the PDCP packets in the second flow for RLC, MAC, and PHY to generate the at least one uplink signal comprising the PDCP packets in the second flow mapped to the second set of at least one carrier.

35. The method of claim 32, wherein the processing the received data comprises processing the received data for Packet Data Convergence Protocol (PDCP) and Radio Link Control (RLC) to generate RLC packets, and wherein the segregating the packets into multiple flows comprises segregating the RLC packets into RLC packets in the first flow and RLC packets in the second flow.

36. The method of claim 35, wherein the sending the packets in the first flow comprises processing the RLC packets in the first flow for Medium Access Control (MAC) and Physical Layer (PHY) to generate at least one uplink signal comprising the RLC packets in the first flow mapped to the first set of at least one carrier, and wherein the sending the packets in the second flow comprises processing the RLC packets in the second flow for MAC and PHY to generate the at least one uplink signal comprising the RLC packets in the second flow mapped to the second set of at least one carrier.

37. An apparatus for wireless communication, comprising:
at least one processor configured to:
receive data at a user equipment (UE) for transmission on uplink;
process the received data to generate packets;
segregate the packets into multiple flows comprising a first flow and a second flow;
send packets in the first flow from the UE to a first node via a first set of at least one carrier; and
send packets in the second flow from the UE to a second node via a second set of at least one carrier, the packets in the second flow being forwarded from the second node to the first node, and the first and second sets of at least one carrier being determined based on a plurality of carriers configured for the UE.

38. The apparatus of claim 37, wherein the configuration of the at least one processor to process the received data comprises configuration to process the received data for Packet Data Convergence Protocol (PDCP) to generate PDCP packets, and wherein the configuration of the at least one processor to segregate the packets into multiple flows comprises configuration to segregate the PDCP packets into PDCP packets in the first flow and PDCP packets in the second flow.

39. The apparatus of claim 38, wherein the configuration of the at least one processor to send the packets in the first flow comprises configuration to process the PDCP packets in the first flow for Radio Link Control (RLC), Medium Access Control (MAC), and Physical Layer (PHY) to generate at least one uplink signal comprising the PDCP packets in the first flow mapped to the first set of at least one carrier, and wherein the configuration of the at least one processor to send the packets in the second flow comprises configuration to process the PDCP packets in the second flow for RLC, MAC, and PHY to generate the at least one uplink signal comprising the PDCP packets in the second flow mapped to the second set of at least one carrier.

40. The apparatus of claim 37, wherein the configuration of the at least one processor to process the received data comprises configuration to process the received data for Packet Data Convergence Protocol (PDCP) and Radio Link Control (RLC) to generate RLC packets, and wherein the configuration of the at least one processor to segregate the packets into multiple flows comprises configuration to segregate the RLC packets into RLC packets in the first flow and RLC packets in the second flow.

41. The apparatus of claim 40, wherein the configuration of the at least one processor to send the packets in the first flow comprises configuration to process the RLC packets in the first flow for Medium Access Control (MAC) and Physical Layer (PHY) to generate at least one uplink signal comprising the RLC packets in the first flow mapped to the first set of at least one carrier, and wherein the configuration of the at least one processor to send the packets in the second flow comprises configuration to process the RLC packets in the second flow for MAC and PHY to generate the at least one uplink signal comprising the RLC packets in the second flow mapped to the second set of at least one carrier.

42. An apparatus for wireless communication, comprising:
means for receiving data at a user equipment (UE) for transmission on uplink;
means for processing the received data to generate packets;
means for segregating the packets into multiple flows comprising a first flow and a second flow;
means for sending packets in the first flow from the UE to a first node via a first set of at least one carrier; and
means for sending packets in the second flow from the UE to a second node via a second set of at least one carrier, the packets in the second flow being forwarded from the second node to the first node, and the first and second sets of at least one carrier being determined based on a plurality of carriers configured for the UE.

43. A computer program product, comprising:
a non-transitory computer-readable medium comprising:
code for causing at least one processor to receive data at a user equipment (UE) for transmission on uplink;
code for causing the at least one processor to process the received data to generate packets;
code for causing the at least one processor to segregate the packets into multiple flows comprising a first flow and a second flow;
code for causing the at least one processor to send packets in the first flow from the UE to a first node via a first set of at least one carrier; and
code for causing the at least one processor to send packets in the second flow from the UE to a second node via a second set of at least one carrier, the packets in the second flow being forwarded from the second node to the first node, and the first and second sets of at least one carrier being determined based on a plurality of carriers configured for the UE.

44. A method for wireless communication, comprising:
receiving packets in a first flow sent from a user equipment (UE) to a first node via a first set of at least one carrier;
receiving packets in a second flow sent from the UE to a second node via a second set of at least one carrier, the packets in the second flow being processed and then forwarded from the second node to the first node, and the first and second sets of at least one carrier being determined based on a plurality of carriers configured for the UE;
aggregating the packets in the first flow and the packets in the second flow; and
processing the aggregated packets to obtain data for the UE.

45. The method of claim 44, wherein the aggregated packets comprise Radio Link Control (RLC) packets, and wherein the processing the aggregated packets comprises processing the RLC packets for Packet Data Convergence Protocol (PDCP) to obtain the data for the UE.

46. The method of claim 45, further comprising:
processing at least one uplink signal from the UE for Physical Layer (PHY), Medium Access Control (MAC), and RLC to obtain RLC packets in the first flow.

47. The method of claim 44, wherein the aggregated packets comprise Medium Access Control (MAC) packets, and wherein the processing the aggregated packets comprises processing the MAC packets for Radio Link Control (RLC) and Packet Data Convergence Protocol (PDCP) to obtain the data for the UE.

48. The method of claim 47, further comprising:
processing at least one uplink signal from the UE for Physical Layer (PHY) and MAC to obtain MAC packets in the first flow.

49. An apparatus for wireless communication, comprising:
at least one processor configured to:
receive packets in a first flow sent from a user equipment (UE) to a first node via a first set of at least one carrier;
receive packets in a second flow sent from the UE to a second node via a second set of at least one carrier, the packets in the second flow being processed and then forwarded from the second node to the first node, and the first and second sets of at least one carrier being determined based on a plurality of carriers configured for the UE;
aggregate the packets in the first flow and the packets in the second flow; and
process the aggregated packets to obtain data for the UE.

50. The apparatus of claim 49, wherein the aggregated packets comprise Radio Link Control (RLC) packets, and wherein the configuration of the at least one processor to process the aggregated packets comprises configuration to process the RLC packets for Packet Data Convergence Protocol (PDCP) to obtain the data for the UE.

51. The apparatus of claim 49, wherein the aggregated packets comprise Medium Access Control (MAC) packets, and wherein the configuration of the at least one processor to process the aggregated packets comprises configuration to process the MAC packets for Radio Link Control (RLC) and Packet Data Convergence Protocol (PDCP) to obtain the data for the UE.

52. An apparatus for wireless communication, comprising:
means for receiving packets in a first flow sent from a user equipment (UE) to a first node via a first set of at least one carrier;
means for receiving packets in a second flow sent from the UE to a second node via a second set of at least one carrier, the packets in the second flow being processed and then forwarded from the second node to the first node, and the first and second sets of at least one carrier being determined based on a plurality of carriers configured for the UE;
means for aggregating the packets in the first flow and the packets in the second flow; and
means for processing the aggregated packets to obtain data for the UE.

53. A computer program product, comprising:
a non-transitory computer-readable medium comprising:
code for causing at least one processor to receive packets in a first flow sent from a user equipment (UE) to a first node via a first set of at least one carrier;
code for causing the at least one processor to receive packets in a second flow sent from the UE to a second node via a second set of at least one carrier, the packets in the second flow being processed and then forwarded from the second node to the first node, and the first and second sets of at least one carrier being determined based on a plurality of carriers configured for the UE;
code for causing the at least one processor to aggregate the packets in the first flow and the packets in the second flow; and
code for causing the at least one processor to process the aggregated packets to obtain data for the UE.

54. A method for wireless communication, comprising:
receiving downlink data sent from a first cell to a user equipment (UE) on a downlink data channel via a first set of at least one carrier; and
sending uplink data from the UE to a second cell on an uplink data channel via a second set of at least one carrier.

55. The method of claim 54, wherein the first set of at least one carrier is different from the second set of at least one carrier.

56. The method of claim 54, wherein the UE is configured with a plurality of carriers, and wherein the first set of at least one carrier and the second set of at least one carrier are determined based on the plurality of carriers configured for the UE.

57. The method of claim 56, wherein each of the plurality of carriers is included in at most one of the first and second sets of at least one carrier.

58. The method of claim 54, wherein the UE is not configured with a downlink data channel for the second cell.

59. The method of claim 54, further comprising:
sending uplink control information (UCI) on an uplink control channel from the UE to the first cell.

60. The method of claim 59, wherein the UCI comprises acknowledgement/negative acknowledgement (ACK/NACK) for the downlink data received from the first cell, or channel state information (CSI), or both.

61. The method of claim 54, further comprising:
receiving first downlink control information (DCI) sent from the first cell to the UE on a first downlink control channel, the first DCI comprising a downlink grant scheduling the UE for downlink data transmission on the downlink data channel; and
receiving second DCI sent from the second cell to the UE on a second downlink control channel, the second DCI comprising an uplink grant scheduling the UE for uplink data transmission on the uplink data channel.

62. The method of claim 54, further comprising:
receiving acknowledgement/negative acknowledgement (ACK/NACK) for the uplink data sent to the second cell, the ACK/NACK being sent by the second cell to the UE on a downlink control channel.

63. An apparatus for wireless communication, comprising:
at least one processor configured to:
receive downlink data sent from a first cell to a user equipment (UE) on a downlink data channel via a first set of at least one carrier; and
send uplink data from the UE to a second cell on an uplink data channel via a second set of at least one carrier.

61. The apparatus of claim 63, wherein the first set of at least one carrier is different from the second set of at least one carrier.

65. The apparatus of claim 63, wherein the UE is configured with a plurality of carriers, and wherein the first set of at least one carrier and the second set of at least one carrier are determined based on the plurality of carriers configured for the UE.

66. The apparatus of claim 65, wherein each of the plurality of carriers is included in at most one of the first and second sets of at least one carrier.

67. The apparatus of claim 63, wherein the UE is not configured with a downlink data channel for the second cell.

68. The apparatus of claim 63, wherein the at least one processor is further configured to send uplink control information (UCI) on an uplink control channel from the UE to the first cell.

69. The apparatus of claim 63, wherein the at least one processor is further configured to:
receive first downlink control information (DCI) sent from the first cell to the UE on a first downlink control channel, the first DCI comprising a downlink grant scheduling the UE for downlink data transmission on the downlink data channel; and
receive second DCI sent from the second cell to the UE on a second downlink control channel, the second DCI comprising an uplink grant scheduling the UE for uplink data transmission on the uplink data channel.

70. An apparatus for wireless communication, comprising:
means for receiving downlink data sent from a first cell to a user equipment (UE) on a downlink data channel via a first set of at least one carrier; and
means for sending uplink data from the UE to a second cell on an uplink data channel via a second set of at least one carrier.

71. A computer program product, comprising:
a non-transitory computer-readable medium comprising:
code for causing at least one processor to receive downlink data sent from a first cell to a user equipment (UE) on a downlink data channel via a first set of at least one carrier; and
code for causing the at least one processor to send uplink data from the UE to a second cell on an uplink data channel via a second set of at least one carrier.
